(19) United States
(12) Patent Application Publication
(10) Pub. No.: US 2026/0270438 A1
(43) Pub. Date: Sep. 10, 2026

(54) IMAGE AND VIDEO CODING AND DECODING

(71) Applicant: CANON KABUSHIKI KAISHA, Tokyo (JP)

(72) Inventors: Guillaume LAROCHE, Cesson-Sévigné (FR); Patrice ONNO, Cesson-Sévigné (FR)

(21) Appl. No.: 19/167,065

(22) PCT Filed: Apr. 8, 2024
(86) PCT No.: PCT/EP2024/059502

§ 371 Date: Sep. 19, 2025

(30) Foreign Application Priority Data
Apr. 12, 2023 (GB) 2305345.7
Jun. 8, 2023 (GB) 2308524.4

(51) Int. Cl. H04N 19/136; H04N 19/172; H04N 19/70

(52) U.S. Cl. CPC H04N 19/136; H04N 19/172; H04N 19/70

(57) ABSTRACT

A method of encoding/decoding video data into/from a bitstream, the bitstream comprising video data corresponding to a plurality of frames arranged in a decoding order, the method comprising: deriving a value from a first area in a first frame of the plurality of frames; and determining, from the value, a context increment for a syntax element, or a syntax element, or a variable related to a second area in a second frame, wherein the first frame precedes the second frame in the decoding order. Devices for performing the methods are also disclosed.

### FIELD OF INVENTION

The present invention relates to encoding and decoding video data from a bitstream, and, more specifically, to encoding and decoding of image and video partitioning data. Devices for decoding video data from, and encoding video data into, a bitstream are also provided, as well as a computer program which is arranged to, upon execution, perform encoding or decoding of video data.

### BACKGROUND

The Joint Video Experts Team (JVET), a collaborative team formed by MPEG and ITU-T Study Group 16's VCEG, released a new video coding standard referred to as Versatile Video Coding (VVC). The goal of VVC is to provide significant improvements in compression performance over the existing HEVC standard (i.e., typically twice as much as before). The main target applications and services include—but not limited to—360-degree and high-dynamic-range (HDR) videos. Particular effectiveness was shown on ultra-high definition (UHD) video test material. Thus, we may expect compression efficiency gains well-beyond the targeted 50% for the final standard.

Since the end of the standardisation of VVC v1, JVET has launched an exploration phase by establishing an exploration software (ECM). It gathers additional tools and improvements of existing tools on top of the VVC standard to target better coding efficiency.

### SUMMARY OF INVENTION

According to a first aspect of the invention there is provided a method of decoding video data from a bitstream, the bitstream comprising video data corresponding to a plurality of frames arranged in a decoding order, the method comprising:
deriving a value from a first area in a first frame of the plurality of frames; and
determining, from the value, a context increment for a syntax element, or a syntax element, or a variable related to a second area in a second frame,
wherein the first frame precedes the second frame in the decoding order.

According to a second aspect of the invention there is provided a method of encoding video data into a bitstream, the bitstream comprising video data corresponding to a plurality of frames arranged in a decoding order, the method comprising:
deriving a value for a first area in a first frame of the plurality of frames; and
determining, from the value, a context increment for a syntax element, or a syntax element, or a variable related to a second area in a second frame,
wherein the first frame precedes the second frame in the decoding order.

Optionally, each frame of the plurality of frames has an associated temporal ID, and the first frame and the second frame have the same temporal ID. Optionally, the first frame corresponds to the closest frame to the second frame, in the decoding order, that has the same temporal ID.

Optionally, each frame of the plurality of frames has an associated quantization parameter, QP, and wherein the first frame and the second frame have the same QP.

Optionally, the first frame is a reference frame.

Optionally, the first area is equal to or larger than the second area in size.

Optionally, the second area corresponds to a coding tree unit, CTU.

Optionally, a size of the first area is set based on a temporal distance between the first frame and the second frame. Optionally, the temporal difference is calculated based on a difference between a picture order count, POC, of the first frame and a POC of the second frame.

Optionally, each frame of the plurality of frames has an associated quantization parameter, QP, and wherein a size of the first area is set based on a difference between a QP of the first frame and a QP of the second frame.

Optionally, each frame of the plurality of frames has an associated temporal ID, and wherein a size of the first area is set based on a difference between a temporal ID of the first frame and a temporal ID of the second frame.

Optionally, a size of the first area is set based on a value transmitted in one of: a sequence parameter set; a picture parameter set; a picture header; and a slice header, contained within the bitstream.

Optionally, a size of the first area is set based on a size of the second area.

Optionally, the step of deriving a value from a first area in a first frame of the plurality of frames comprises deriving a value from a block that has at least one sample within the first area.

Optionally, the step of deriving a value from a first area in a first frame of the plurality of frames comprises deriving a value from all blocks having at least one sample within the first area.

Optionally, the step of deriving a value from a first area in a first frame of the plurality of frames comprises weighting the value derived from the or each block based on the number of samples of each block has within the first area.

Optionally, the step of deriving a value from a first area in a first frame of the plurality of frames comprises deriving a value only from blocks that are completely contained within the first area.

Optionally, the step of deriving a value from a first area in a first frame of the plurality of frames comprises deriving a value only from blocks that are located on an N×N grid within the first area, where N is an integer. Optionally, N=16.

Optionally, a center of the grid is located at the same position within the first frame as a center of the first area with the first frame.

Optionally, the step of deriving a value from a first area in a first frame of the plurality of frames comprises deriving a value only from blocks that are located on points of a pattern within the first area. Optionally, the points of the pattern are spaced in a non-uniform manner.

Optionally, the step of determining, from the value, a context increment for a syntax element, or a syntax element, or a variable, related to a second area in a second frame comprises determining a context increment for a syntax element, or a syntax element, or a variable related to a block within the second area.

Optionally, the step of determining, from the value, a context increment for a syntax element, or a syntax element, or a variable, related to a second area in a second frame comprises determining a context increment for a syntax element, or a syntax element, or a variable, related to blocks located on an M×M grid within the second area, where M is an integer. Optionally, the M×M grid is shifted by M/2 in a horizontal direction and M/2 in a vertical direction relative to a top-left position of the second area.

Optionally, a center of the first area is located at the same position within the first frame as a center of the second area within the second frame.

Optionally, the center of the first area is located at the position within the first frame corresponding to a center of the second area within the second frame shifted by an amount corresponding to a motion vector derived from an area neighbouring the second area.

Optionally, the method further comprises, when the center of the first area lies outside the first frame, deriving a value from a top left position of the first area.

Optionally, the step of deriving a value from a first area in a first frame of the plurality of frames comprises accessing each block within the first area only once.

Optionally, the step of deriving a value from a first area in a first frame of the plurality of frames comprises:

deriving a value from a first area in a first frame of the plurality of frames and a third area in a third frame of the plurality of frames.

Optionally, the step of determining, from the value, a context increment for a syntax element, or a syntax element, or a variable, related to a second area in a second frame, comprises determining a predictor to be added to a residual derived from the bitstream.

Optionally, the value derived from the first area comprises maxMttDepth, and the step of determining, from the value, a context increment for a syntax element, or a syntax element, or a variable, related to a second area in a second frame comprises determining maxMttDepth for a block of the second area.

Optionally, the value derived from the first area is used to limit the context increment for a variable, or syntax element, related to the second area.

Optionally, the value derived from the first area is a minimum of quadtree depth values, minQTDepth, from the blocks of the first area, and the step of determining, from the value, a context increment for a syntax element, or a syntax element, or a variable, related to a second area in a second frame comprises comparing the derived minQTDepth to a quadtree depth of a block in the second area to determine if only the quadtree split is allowed.

Optionally, the value derived from the first area is a maximum maximum of multi tree depth values, maxMttDepth, from the blocks of the first area, and the step of determining, from the value, a context increment for a syntax element, or a syntax element, or a variable, related to a second area in a second frame comprises comparing the derived maxMttDepth to a maxMttDepth of a block in the second area, and varying maxMttDepth based on the comparison.

Optionally, the value derived from the first area is an average of quadtree depth values from the blocks of the first area, and the step of determining, from the value, a context increment for a syntax element, or a syntax element, or a variable, related to a second area in a second frame comprises comparing the derived quadtree depth values to a quadtree depth of a block in the second area. Optionally, the method further comprises the step of determining allowable splits based on the comparison. Optionally, the method further comprises the step of varying maxMttDepth based on the comparison.

In accordance with a third aspect of the invention there is provided a device for decoding video data from a bitstream, wherein the device is configured to perform the method of the first aspect.

In accordance with a fourth aspect of the invention there is provided a device for encoding video data into a bitstream, wherein the device is configured to perform the method of the second aspect.

In accordance with a fifth aspect of the invention there is provided a computer program which is arranged to, upon execution, perform the method of the first or second aspect.

### BRIEF DESCRIPTION OF THE DRAWINGS

Reference will now be made, by way of example, to the accompanying drawings, in which:

FIG. 1 is a diagram for use in explaining a coding structure used in HEVC;

FIG. 2 is a block diagram schematically illustrating a data communication system in which one or more embodiments of the invention may be implemented;

FIG. 3 is a block diagram illustrating components of a processing device in which one or more embodiments of the invention may be implemented;

FIG. 4 is a schematic illustrating functional elements of an encoder according to embodiments of the invention;

FIG. 5 is a schematic illustrating functional elements of a decoder according to embodiments of the invention;

FIG. 6 shows blocks positioned relative to a current block including a collocated block;

FIGS. 7(a) and (b) illustrate the Affine (SubBlock) mode;

FIG. 8 illustrates the SubBlock temporal merge candidate;

FIG. 9 illustrates a temporal random-access GOP structure for 33 frames with the related Temporal ID and POC.

FIG. 10 illustrates the 6 possible splits modes of VVC.

FIG. 11 illustrates the MaxBTSize and MaxMttDepth.

FIG. 12 illustrates an example of MinQTSize variable.

FIG. 13 illustrates possible partitioning constraints.

FIG. 14 illustrates incomplete CTUs in the borders of a frame.

FIG. 15 illustrates an encoding by setting MaxMttDepth based on the temporal ID.

FIG. 16 illustrates one embodiment of the invention.

FIG. 17 illustrates one example of one embodiment of the invention.

FIG. 18 illustrates one embodiment of the invention.

FIG. 19 illustrates one embodiment of the invention.

FIG. 20 is a diagram showing a system comprising an encoder or a decoder and a communication network according to embodiments of the present invention.

FIG. 21 is a schematic block diagram of a computing device for implementation of one or more embodiments of the invention;

FIG. 22 is a diagram illustrating a network camera system;

FIG. 23 is a diagram illustrating a smart phone;

### DETAILED DESCRIPTION

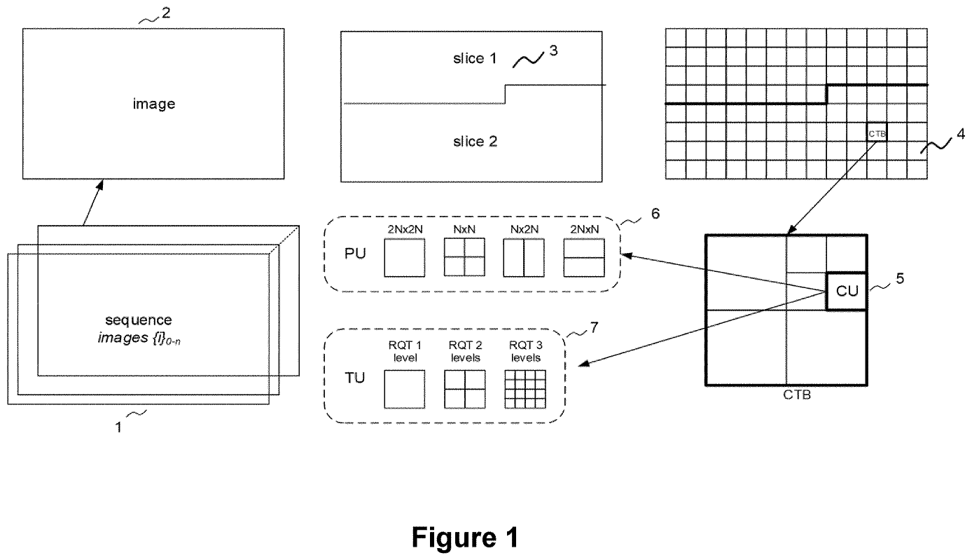

FIG. 1 relates to a coding structure used in the High Efficiency Video Coding (HEVC) video and Versatile Video Coding (VVC) standards. A video sequence 1 is made up of a succession of digital images i. Each such digital image is represented by one or more matrices. The matrix coefficients represent pixels.

An image 2 of the sequence may be divided into slices 3. A slice may in some instances constitute an entire image. These slices are divided into non-overlapping Coding Tree Units (CTUs). A Coding Tree Unit (CTU) is the basic processing unit of the High Efficiency Video Coding (HEVC) and Versatile Video Coding (VVC) video standards and conceptually corresponds in structure to macroblock units that were used in several previous video standards. A CTU is also sometimes referred to as a Largest Coding Unit (LCU). A CTU has luma and chroma component parts, each of which component parts is called a Coding Tree Block (CTB). These different color components are not shown in FIG. 1.

A CTU is generally of size 64 pixels×64 pixels for HEVC, yet for VVC this size can be 128 pixels×128 pixels. Each CTU may in turn be iteratively divided into smaller variable-size Coding Units (CUs) 5 using a quadtree (QT) decomposition.

Coding units are the elementary coding elements and are constituted by two kinds of sub-unit called a Prediction Unit (PU) and a Transform Unit (TU). The maximum size of a PU or TU is equal to the CU size. A Prediction Unit corresponds to the partition of the CU for prediction of pixels values. Various different partitions of a CU into PUs are possible as shown by 6 including a partition into 4 square PUs and two different partitions into 2 rectangular PUs. A Transform Unit is an elementary unit that is subjected to spatial transformation using a discrete cosine transform (DCT). A CU can be partitioned into TUs based on a quadtree representation 7.

Each slice is embedded in one Network Abstraction Layer (NAL) unit. In addition, the coding parameters of the video sequence are stored in dedicated NAL units called parameter sets. In HEVC and H.264/AVC two kinds of parameter sets NAL units are employed: first, a Sequence Parameter Set (SPS) NAL unit that gathers all parameters that are unchanged during the whole video sequence. Typically, it handles the coding profile, the size of the video frames and other parameters. Secondly, a Picture Parameter Set (PPS) NAL unit includes parameters that may change from one image (or frame) to another of a sequence. HEVC also includes a Video Parameter Set (VPS) NAL unit which contains parameters describing the overall structure of the bitstream. The VPS is a type of parameter set defined in HEVC and applies to all of the layers of a bitstream. A layer may contain multiple temporal sub-layers, and all version 1 bitstreams are restricted to a single layer. HEVC has certain layered extensions for scalability and multiview and these will enable multiple layers, with a backwards compatible version 1 base layer.

Other ways of splitting an image have been introduced in VVC including subpictures, which are independently coded groups of one or more slices.

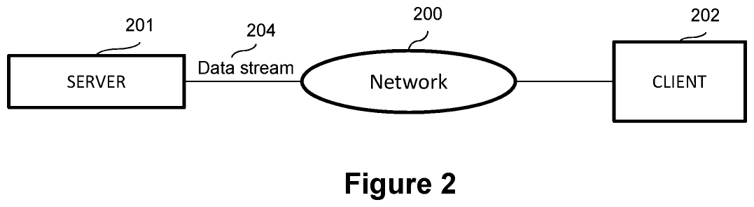

FIG. 2 illustrates a data communication system in which one or more embodiments of the invention may be implemented. The data communication system comprises a transmission device, in this case a server 201, which is operable to transmit data packets of a data stream to a receiving device, in this case a client terminal 202, via a data communication network 200. The data communication network 200 may be a Wide Area Network (WAN) or a Local Area Network (LAN). Such a network may be for example a wireless network (Wifi/802.11a or b or g), an Ethernet network, an Internet network or a mixed network composed of several different networks. In a particular embodiment of the invention the data communication system may be a digital television broadcast system in which the server 201 sends the same data content to multiple clients.

The data stream 204 provided by the server 201 may be composed of multimedia data representing video and audio data. Audio and video data streams may, in some embodiments of the invention, be captured by the server 201 using a microphone and a camera respectively. In some embodiments data streams may be stored on the server 201 or received by the server 201 from another data provider or generated at the server 201. The server 201 is provided with an encoder for encoding video and audio streams, in particular, to provide a compressed bitstream for transmission that is a more compact representation of the data presented as input to the encoder.

In order to obtain a better ratio of the quality of transmitted data to quantity of transmitted data, the compression of the video data may be for example in accordance with the HEVC format or H.264/AVC format or VVC format or the format of data generated by the ECM.

The client 202 receives the transmitted bitstream and decodes the reconstructed bitstream to reproduce video images on a display device and the audio data by a loud speaker.

Although a streaming scenario is considered in the example of FIG. 2, it will be appreciated that in some embodiments of the invention the data communication between an encoder and a decoder may be performed using for example a media storage device such as an optical disc.

In one or more embodiments of the invention a video image is transmitted with data representative of compensation offsets for application to reconstructed pixels of the image to provide filtered pixels in a final image.

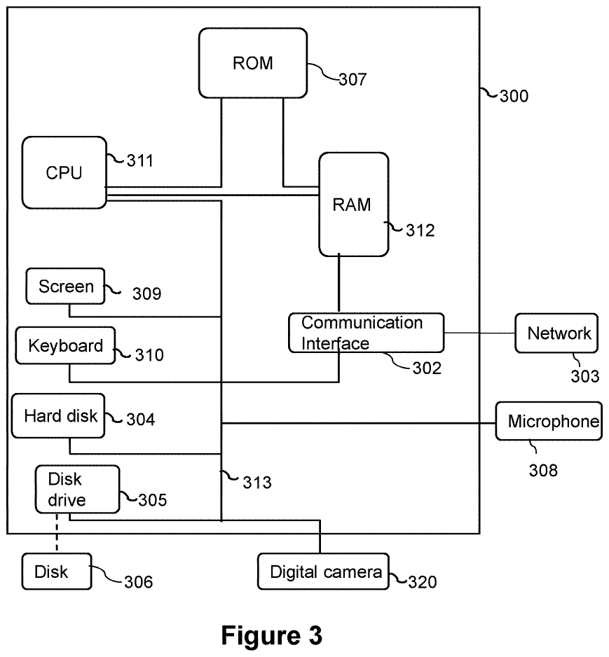

FIG. 3 schematically illustrates a processing device 300 configured to implement at least one embodiment of the present invention. The processing device 300 may be a device such as a micro-computer, a workstation or a light portable device. The device 300 comprises a communication bus 313 connected to:
a central processing unit 311, such as a microprocessor, denoted CPU;
a read only memory 306, denoted ROM, for storing computer programs for implementing the invention;
a random access memory 312, denoted RAM, for storing the executable code of the method of embodiments of the invention as well as the registers adapted to record variables and parameters necessary for implementing the method of encoding a sequence of digital images and/or the method of decoding a bitstream according to embodiments of the invention; and
a communication interface 302 connected to a communication network 303 over which digital data to be processed are transmitted or received

Optionally, the apparatus 300 may also include the following components:
a data storage means 304 such as a hard disk, for storing computer programs for implementing methods of one or more embodiments of the invention and data used or produced during the implementation of one or more embodiments of the invention;
a disk drive 305 for a disk 306, the disk drive being adapted to read data from the disk 306 or to write data onto said disk;
a screen 309 for displaying data and/or serving as a graphical interface with the user, by means of a keyboard 310 or any other pointing means.

The apparatus 300 can be connected to various peripherals, such as for example a digital camera 320 or a microphone 308, each being connected to an input/output card (not shown) so as to supply multimedia data to the apparatus 300.

The communication bus provides communication and interoperability between the various elements included in the apparatus 300 or connected to it. The representation of the bus is not limiting and in particular the central processing unit is operable to communicate instructions to any element of the apparatus 300 directly or by means of another element of the apparatus 300.

The disk 306 can be replaced by any information medium such as for example a compact disk (CD-ROM), rewritable or not, a ZIP disk or a memory card and, in general terms, by an information storage means that can be read by a microcomputer or by a microprocessor, integrated or not into the apparatus, possibly removable and adapted to store one or more programs whose execution enables the method of encoding a sequence of digital images and/or the method of decoding a bitstream according to the invention to be implemented.

The executable code may be stored either in read only memory 306, on the hard disk 304 or on a removable digital medium such as for example a disk 306 as described previously. According to a variant, the executable code of the programs can be received by means of the communication network 303, via the interface 302, in order to be stored in one of the storage means of the apparatus 300 before being executed, such as the hard disk 304.

The central processing unit 311 is adapted to control and direct the execution of the instructions or portions of software code of the program or programs according to the invention, instructions that are stored in one of the aforementioned storage means. On powering up, the program or programs that are stored in a non-volatile memory, for example on the hard disk 304 or in the read only memory 306, are transferred into the random access memory 312, which then contains the executable code of the program or programs, as well as registers for storing the variables and parameters necessary for implementing the invention.

In this embodiment, the apparatus is a programmable apparatus which uses software to implement the invention. However, alternatively, the present invention may be implemented in hardware (for example, in the form of an Application Specific Integrated Circuit or ASIC).

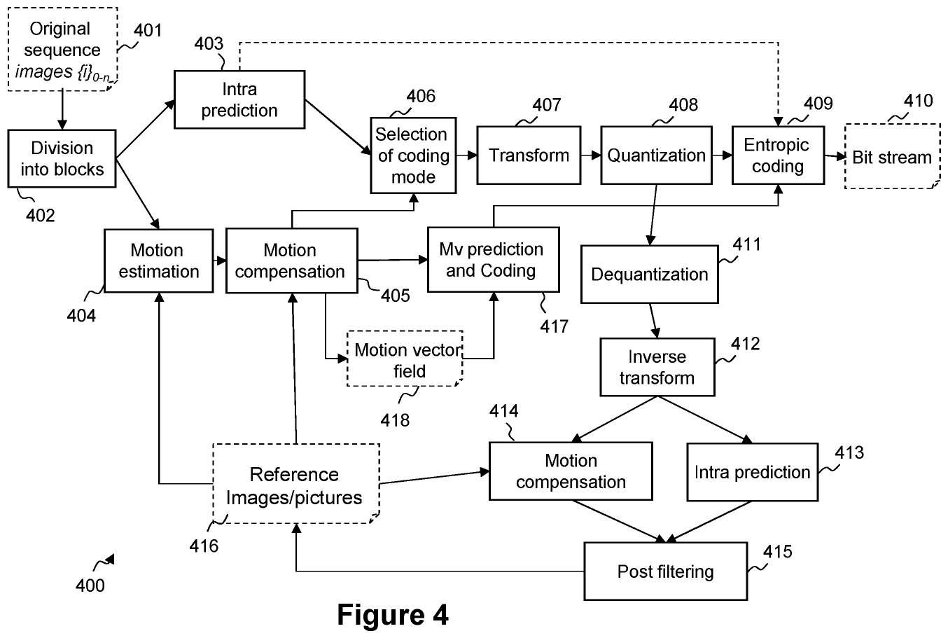

FIG. 4 illustrates a block diagram of an encoder according to at least one embodiment of the invention. The encoder is represented by connected modules, each module being adapted to implement, for example in the form of programming instructions to be executed by the CPU 311 of device 300, at least one corresponding step of a method implementing at least one embodiment of encoding an image of a sequence of images according to one or more embodiments of the invention.

An original sequence of digital images i0 to in 401 is received as an input by the encoder 400. Each digital image is represented by a set of samples, sometimes also referred to as pixels (hereinafter, they are referred to as pixels).

A bitstream 410 is output by the encoder 400 after implementation of the encoding process. The bitstream 410 comprises a plurality of encoding units or slices, each slice comprising a slice header for transmitting encoding values of encoding parameters used to encode the slice and a slice body, comprising encoded video data.

The input digital images i₀ to iₙ 401 are divided into blocks of pixels by module 402. The blocks correspond to image portions and may be of variable sizes (e.g. 4×4, 8×8, 16×16, 32×32, 64×64, 128×128 pixels and several rectangular block sizes can be also considered). A coding mode is selected for each input block. Two families of coding modes are provided: coding modes based on spatial prediction coding (Intra prediction), and coding modes based on temporal prediction (Inter coding, Merge, SKIP). The possible coding modes are tested.

Module 403 implements an Intra prediction process, in which the given block to be encoded is predicted by a predictor computed from pixels of the neighbourhood of said block to be encoded. An indication of the selected Intra predictor and the difference between the given block and its predictor is encoded to provide a residual if the Intra coding is selected.

Temporal prediction is implemented by motion estimation module 404 and motion compensation module 405. Firstly, a reference image from among a set of reference images 416 is selected, and a portion of the reference image, also called reference area or image portion, which is the closest area (closest in terms of pixel value similarity) to the given block to be encoded, is selected by the motion estimation module 404. Motion compensation module 405 then predicts the block to be encoded using the selected area. The difference between the selected reference area and the given block, also called a residual block, is computed by the motion compensation module 405. The selected reference area is indicated using a motion vector.

Thus, in both cases (spatial and temporal prediction), a residual is computed by subtracting the predictor from the original block.

In the INTRA prediction implemented by module 403, a prediction direction is encoded. In the Inter prediction implemented by modules 404, 405, 416, 418, 417, at least one motion vector or data for identifying such motion vector is encoded for the temporal prediction.

Information relevant to the motion vector and the residual block is encoded if the Inter prediction is selected. To further reduce the bitrate, assuming that motion is homogeneous, the motion vector is encoded by difference with respect to a motion vector predictor. Motion vector predictors from a set of motion information predictor candidates is obtained from the motion vectors field 418 by a motion vector prediction and coding module 417.

The encoder 400 further comprises a selection module 406 for selection of the coding mode by applying an encoding cost criterion, such as a rate-distortion criterion. In order to further reduce redundancies a transform (such as DCT) is applied by transform module 407 to the residual block, the transformed data obtained is then quantized by quantization module 408 and entropy encoded by entropy encoding module 409. Finally, the encoded residual block of the current block being encoded is inserted into the bitstream 410.

The encoder 400 also performs decoding of the encoded image in order to produce a reference image (e.g. those in Reference images/pictures 416) for the motion estimation of the subsequent images. This enables the encoder and the decoder receiving the bitstream to have the same reference frames (reconstructed images or image portions are used). The inverse quantization (“dequantization”) module 411 performs inverse quantization (“dequantization”) of the quantized data, followed by an inverse transform by inverse transform module 412. The intra prediction module 413 uses the prediction information to determine which predictor to use for a given block and the motion compensation module 414 actually adds the residual obtained by module 412 to the reference area obtained from the set of reference images 416.

Post filtering is then applied by module 415 to filter the reconstructed frame (image or image portions) of pixels. In the embodiments of the invention an SAO loop filter is used in which compensation offsets are added to the pixel values of the reconstructed pixels of the reconstructed image. It is understood that post filtering does not always have to performed. Also, any other type of post filtering may also be performed in addition to, or instead of, the SAO loop filtering.

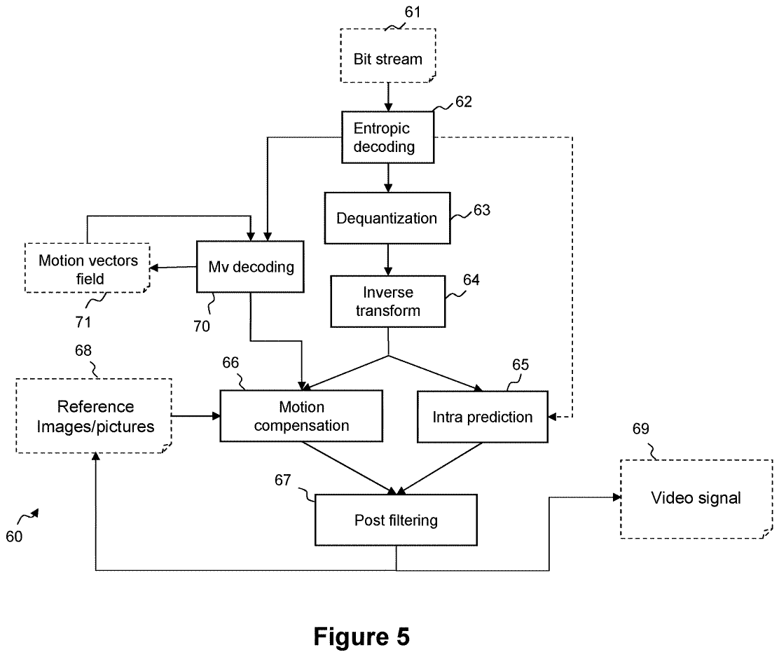

FIG. 5 illustrates a block diagram of a decoder 60 which may be used to receive data from an encoder according an embodiment of the invention. The decoder is represented by connected modules, each module being adapted to implement, for example in the form of programming instructions to be executed by the CPU 311 of device 300, a corresponding step of a method implemented by the decoder 60.

The decoder 60 receives a bitstream 61 comprising encoded units (e.g. data corresponding to a block or a coding unit), each one being composed of a header containing information on encoding parameters and a body containing the encoded video data. As explained with respect to FIG. 4, the encoded video data is entropy encoded, and the motion vector predictors' indexes are encoded, for a given block, on a predetermined number of bits. The received encoded video data is entropy decoded by module 62. The residual data are then dequantized by module 63 and then an inverse transform is applied by module 64 to obtain pixel values.

The mode data indicating the coding mode are also entropy decoded and based on the mode, an INTRA type decoding or an INTER type decoding is performed on the encoded blocks (units/sets/groups) of image data.

In the case of INTRA mode, an INTRA predictor is determined by intra prediction module 65 based on the intra prediction mode specified in the bitstream.

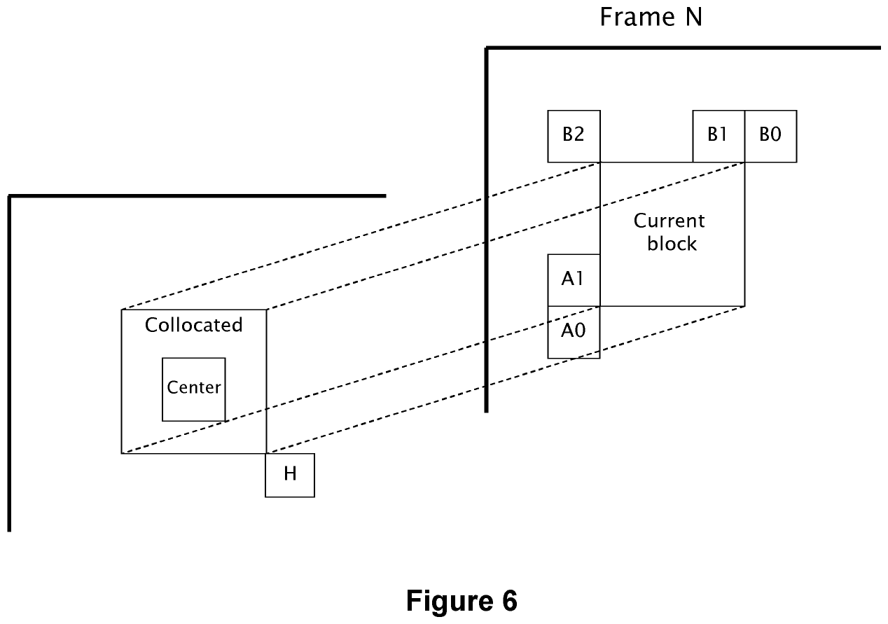

If the mode is INTER, the motion prediction information is extracted from the bitstream so as to find (identify) the reference area used by the encoder. The motion prediction information comprises the reference frame index and the motion vector residual. The motion vector predictor is added to the motion vector residual by motion vector decoding module 70 in order to obtain the motion vector. The various motion predictor tools used in VVC are discussed in more detail below with reference to FIGS. 6-10.

Motion vector decoding module 70 applies motion vector decoding for each current block encoded by motion prediction. Once an index of the motion vector predictor for the current block has been obtained, the actual value of the motion vector associated with the current block can be decoded and used to apply motion compensation by module 66. The reference image portion indicated by the decoded motion vector is extracted from a reference image 68 to apply the motion compensation 66. The motion vector field data 71 is updated with the decoded motion vector in order to be used for the prediction of subsequent decoded motion vectors. Please note that in VVC as in HEVC the motion vectors are stored at 16×16 level and not at 4×4 for the temporal predictor. It means that a decimation is applied only for the temporal predictor and not for the spatial predictors. Indeed, the aim is to reduce the buffer needed to store the temporal motion vectors after the coding of each frame. This has a negative impact on the coding efficiency and generally this decimation are removed from the exploration software.

Finally, a decoded block is obtained. Where appropriate, post filtering is applied by post filtering module 67. A decoded video signal 69 is finally obtained and provided by the decoder 60.

### VVC Merge Modes

In VVC several inter modes have been added compared to HEVC. In particular, new Merge modes have been added to the regular Merge mode of HEVC.

### Affine Mode (SubBlock Mode)

In HEVC, only translation motion model is applied for motion compensation prediction (MCP). While in the real world, there are many kinds of motion, e.g. zoom in/out, rotation, perspective motions and other irregular motions.

In the JEM, a simplified affine transform motion compensation prediction is applied and the general principle of Affine mode is described below based on an extract of document JVET-G1001 presented at a JVET meeting in Torino at 13-21 Jul. 2017. This entire document is hereby incorporated by reference insofar as it describes other algorithms used in JEM.

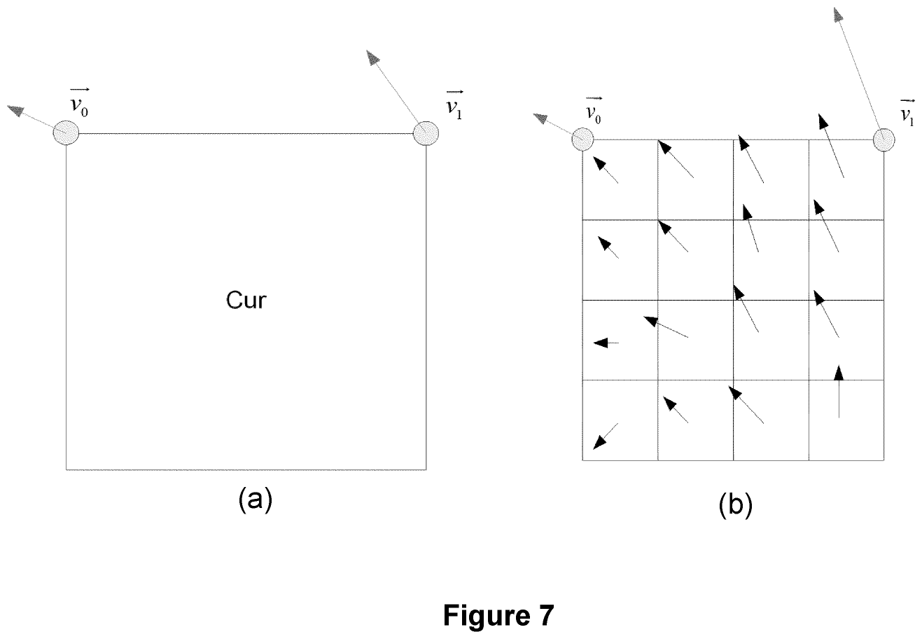

As shown in FIG. 7(a), the affine motion field of the block is described by two control point motion vectors.

The affine mode is a motion compensation mode like the Inter modes (AMVP, “classical” Merge, or “classical” Merge Skip). Its principle is to generate one motion information per pixel according to 2 or 3 neighbouring motion information. In the JEM, the affine mode derives one motion information for each 4×4 block as depicted in FIG. 7(a) (each square is a 4×4 block, and the whole block in FIG. 7(a) is a 16×16 block which is divided into 16 blocks of such square of 4×4 size—each 4×4 square block having a motion vector associated therewith). The Affine mode is available for the AMVP mode and the Merge modes (i.e. the classical Merge mode which is also referred to as “non-Affine Merge mode” and the classical Merge Skip mode which is also referred to as “non-Affine Merge Skip mode”), by enabling the affine mode with a flag.

In the VVC specification the Affine Mode is also known as SubBlock mode; these terms are used interchangeably in this specification.

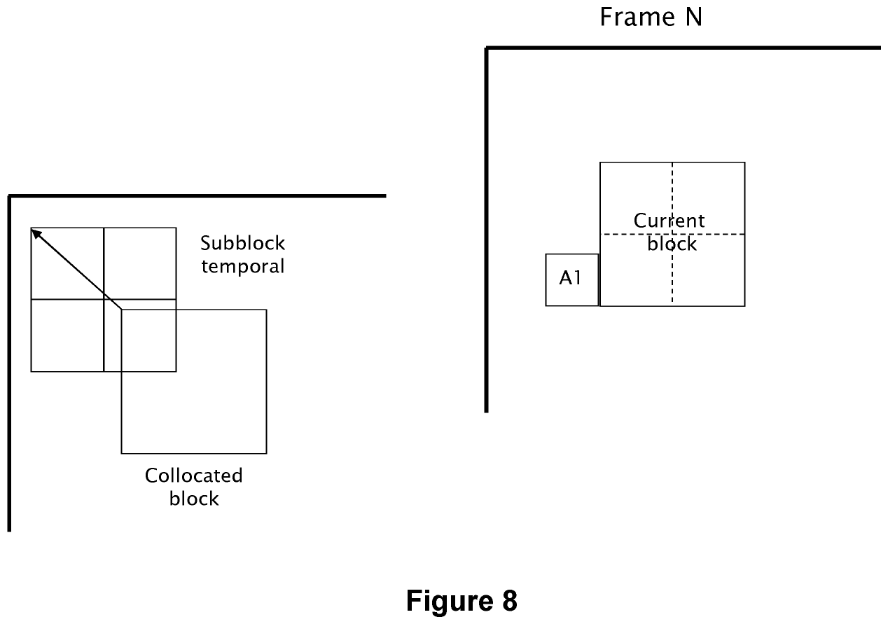

The subblock Merge mode of VVC contains a subblock-based temporal merging candidates, which inherit the motion vector field of a block in a previous frame pointed by a spatial motion vector candidate A1 as depicted in FIG. 8. In this figure the predictor for the current is not the collocated block but a block shifted by the motion vector value of A1.

This subblock candidate is followed by inherited affine motion candidate if the neighboring blocks have been coded with an inter affine mode of subblock merge and then some as constructed affine candidates are derived before some zero Mv candidate.

### Context Index Increment

The Context-based Adaptive Binary Arithmetic Coding (CABAC), uses context to separate the probabilities of one or more bins. To obtain the corresponding contexts of a bin and its relative states, a context index increment ctxInc is computed.

For example, the following formula gives an example of context index increment:

$$ctxInc = ( condL \&\& availableL ) \vert \vert ( condA \&\& availableA )$$

Where condL is the value of the related left syntax element and condA is the value of the related above syntax element. availableL and availableA are respectively the availability value of the block left and above.

### Random Access Configuration

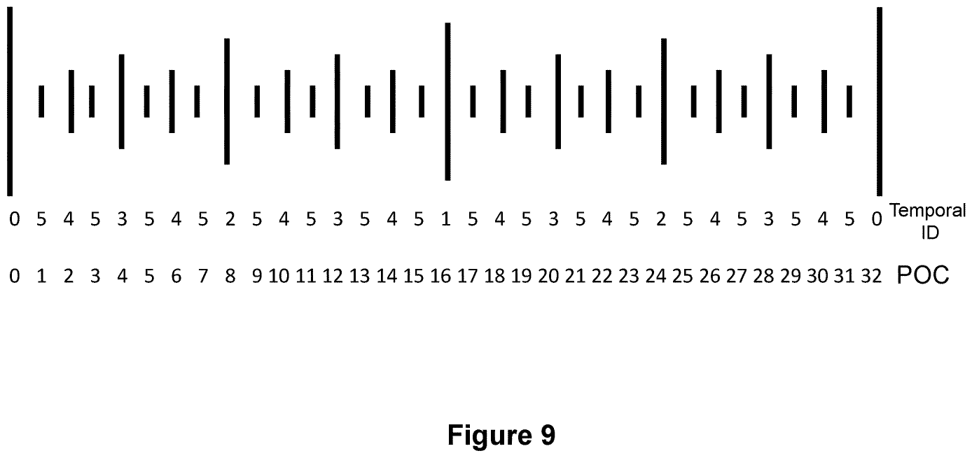

FIG. 9 shows a temporal random-access GOP structure for 33 consecutive frames 0 to 32. The length of the vertical line representing each frame corresponds their temporal ID. (e.g. the longest length corresponds temporal ID 0 and the shortest length for temporal ID 5). The frames with a temporal ID 0 are the highest in the temporal hierarchy because they can be decoded independently to all others frames lower in the temporal hierarchy, i.e. those with numerically higher temporal ID values. In the same way, the frames with a temporal ID 1 are in the second in the temporal hierarchy and they can be decoded independently to all others frames that are lower in the temporal hierarchy, i.e. those with a higher temporal ID and so on for the other temporal IDs. In other words, a frame with a particular temporal ID can be decoded independently from frames with temporal IDs higher in value but may be dependent on frames with lower temporal IDs. This is what is known as temporal scalability.

This parameter is similar to the hierarchy depth but the hierarchy depth does not imply the independence of decoding to all other frames with a higher depth.

### VVC Partitioning

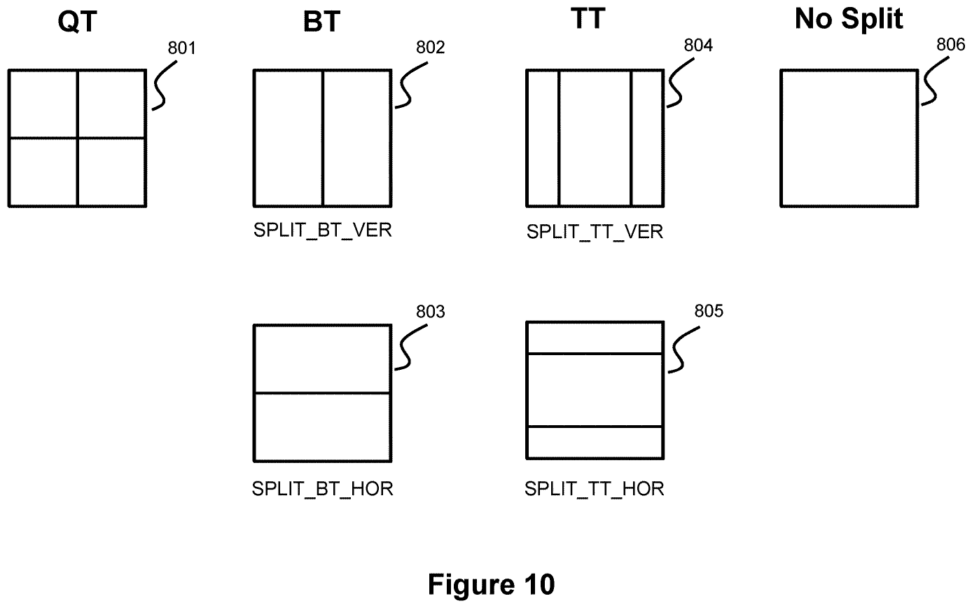

The VVC Partitioning has a specific block partitioning. For one tree node, 6 possible splits are possible as depicted in FIG. 10:
The quad split QT,801, which divides a block into 4 equally sized square blocks
The binary split BT with its two possible subdivisions 802, 803:
   the vertical binary split, 802, SPLIT_BT_VER
   the horizontal binary split, 803, SPLIT_BT_HOR
The ternary split TT with its 2 possible subdivisions 804, 805 where the block is split into 3 blocks with a larger band in the middle:
   the vertical ternary split, 804, SPLIT_TT_VER
   the horizontal ternary split, 805, SPLIT_TT_HOR
The No Split, 806, which terminates a tree node so there is no splitting.

In this description a block may be a CTU and/or CU or more generally any unit in a coding tree.

### VVC Splitting Control Variables

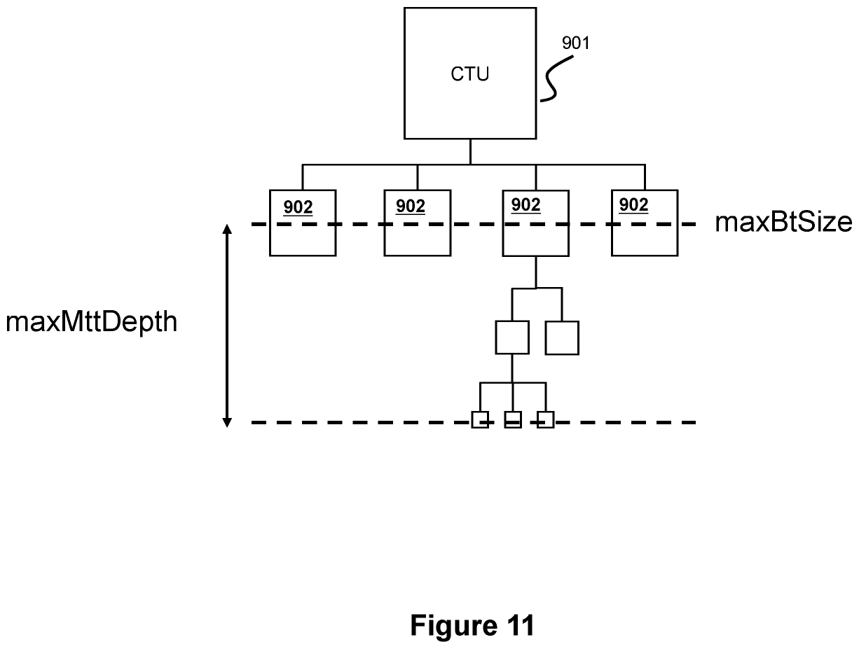

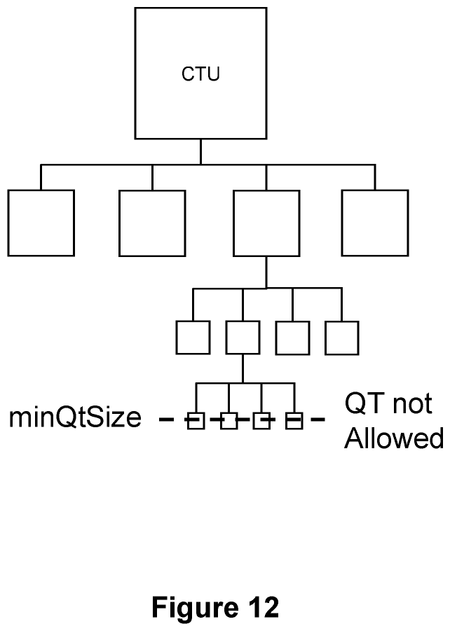

For a current block not all the possible splits are always permitted. Which splits are available depends on several conditions. These conditions depend on several splitting control variables which have been defined. A first set of variables define the maximum and the minimum block/node size:
CTU size: it corresponds to the root node size of a quadtree (for example 256×256, 128×128, 64×64, 32×32, 16×16 luma samples);
maxBtSize: is the maximum allowed binary tree root node size, i.e., the maximum size of a leaf quadtree node that may be partitioned by binary splitting. A current block can be split thanks to a BT split if both height and width of the current block are less than or equal to maxBtSize. FIG. 11 illustrates the concept of maxBtSize where the maxBtSize is the size of the quad tree leaf nodes 902 of a CTU 901
minBtSize: is the minimum allowed binary tree leaf node size; i.e., the minimum width or height of a binary leaf node. So, a current block can be split thanks to a horizontal BT split if its height is greater than minBtSize. And a current block can be split thanks to a vertical BT split if its width is greater than minBtSize.
maxTtSize: is the maximum allowed ternary tree root node size, i.e., the maximum size of a leaf quadtree node that may be partitioned by ternary splitting. A current block can be split thanks to a TT split if both height and width of the current block are inferior or equal to maxTtSize.
minTtSize: represents the minimum allowed ternary tree (TT) leaf node size; i.e., the minimum width or height of a binary leaf node. But in contrast to the BT Split, to be allowed a minimum TT partition size is considered. So, a current block can be split thanks to a horizontal TT split if its height is greater than twice the minTtSize. And a current block can be split thanks to a vertical TT split if its width is strictly greater than twice times the minTtSize.
minQtSize: is the minimum allowed quadtree (QT) leaf node size; So, for the current block if the current block width is not greater than the minQtSize, the QT split mode is not allowed. FIG. 12 illustrates an example of minQtSize. By considering a CTU 128, in the illustrated example the minQtsize is equal to 16.

There is no definition of a maxQtSize, so it corresponds to the CTU size.

The minimum allowed block size for the width and the height is 4.

A set of depths are also defined.
Depth: is the depth in the tree. In VVC specification a leaf is a terminating node of a tree that is a root node of a tree of depth 0. It means that for each split this value is incremented (by 1).
mttDepth: it is the depth of multi tree. The multi tree includes BT splits and TT splits.
The maxMttDepth is defined in VVC specification which is the maximum allowed multi tree depth. So, mttDepth is greater than or equal to maxMttDepth. FIG. 11 illustrates the concept of maxMttDepth.
   In VVC these variables are defined independently for Luma and Chroma.

In the VTM software and ECM software, there is several other variables corresponding to depths.

The variable currBtDepth is the current number of BT splits used to reach the current tree node (or the current block). The variable currMttDepth is the current number of BT splits and TT splits used to reach the current tree node (or the current block). The variable maxBtDepth corresponds to the variable maxMttDepth of the VVC specification. The currQtDepth is the current number of QT splits used to reach the current tree node (or the current block). MaxBtDepth: is the maximum allowed binary tree depth, i.e., the lowest level at which binary splitting may occur, where the quadtree leaf node is the root (e.g., 3).

### VVC Splitting Control Syntax Elements

To set the values of these different variables, some high-level syntax elements are transmitted in the SPS as depicted in the following table of SPS syntax elements

| | Descriptor |
|---|---|
| seq_parameter_set_rbsp( ) { | |
| ... | |
| sps_log2_min_luma_coding_block_size_minus2 | ue(v) |
| sps_partition_constraints_override_enabled_flag | u(1) |
| sps_log2_diff_min_qt_min_cb_intra_slice_luma | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_chroma_format_idc != 0 ) | |
| sps_qtbtt_dual_tree_intra_flag | u(1) |
| if( sps_qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if( sps_max_mtt_hierarchy_depth_intra_slice_chroma != 0 ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| sps_log2_diff_min_qt_min_cb_inter_slice | ue(v) |
| sps_max_mtt_hierarchy_depth_inter_slice | ue(v) |
| if( sps_max_mtt_hierarchy_depth_inter_slice != 0 ) { | |
| sps_log2_diff_max_bt_min_qt_inter_slice | ue(v) |
| sps_log2_diff_max_tt_min_qt_inter_slice | ue(v) |
| } | |
| ... | |

When the sps_partition_constraints_override_enabled_flag is enabled in the SPS, some picture header syntax elements are transmitted to update the partitioning variables as depicted in the following table of PH syntax elements.

| | Descriptor |
|---|---|
| picture_header_structure( ) { | |
| ... | |
| if( sps_partition_constraints_override_enabled_flag ) | |
| ph_partition_constraints_override_flag | u(1) |
| if( ph_intra_slice_allowed_flag ) { | |
| if( ph_partition_constraints_override_flag ) { | |
| ph_log2_diff_min_qt_min_cb_intra_slice_luma | ue(v) |
| ph_max_mtt_hierarchy_depth_intra_slice_luma | ue(v) |
| if( ph_max_mtt_hierarchy_depth_intra_slice_luma != 0 ) { | |
| ph_log2_diff_max_bt_min_qt_intra_slice_luma | ue(v) |
| ph_log2_diff_max_tt_min_qt_intra_slice_luma | ue(v) |
| } | |
| if( sps_qtbtt_dual_tree_intra_flag ) { | |
| ph_log2_diff_min_qt_min_cb_intra_slice_chroma | ue(v) |
| ph_max_mtt_hierarchy_depth_intra_slice_chroma | ue(v) |
| if( ph_max_mtt_hierarchy_depth_intra_slice_chroma != 0 ) { | |
| ph_log2_diff_max_bt_min_qt_intra_slice_chroma | ue(v) |
| ph_log2_diff_max_tt_min_qt_intra_slice_chroma | ue(v) |
| } | |
| } | |
| } | |
| ... | |
| } | |
| if( ph_inter_slice_allowed_flag ) { | |
| if( ph_partition_constraints_override_flag ) { | |
| ph_log2_diff_min_qt_min_cb_inter_slice | ue(v) |
| ph_max_mtt_hierarchy_depth_inter_slice | ue(v) |
| if( ph_max_mtt_hierarchy_depth_inter_slice != 0 ) { | |
| ph_log2_diff_max_bt_min_qt_inter_slice | ue(v) |
| ph_log2_diff_max_tt_min_qt_inter_slice | ue(v) |
| } | |
| } | |
| ... | |

### VVC Coding Split Mode

In VVC, the coding split mode is transmitted in the coding_tree as depicted in the following syntax table where the conditionally parsed flags, split_cu_flag, split_qt_flag, mtt_split_cu_vertical_flag, mtt_split_cu_binary flag define the splitting of a CU.

| | Descriptor |
|---|---|
| coding_tree( x0, y0, cbWidth, cbHeight, qgOnY, qgOnC, cbSubdiv, cqtDepth, mttDepth, | |
| depthOffset, partIdx, treeTypeCurr, modeTypeCurr ) { | |
| if( ( allowSplitBtVer ∥ allowSplitBtHor ∥ allowSplitTtVer ∥ allowSplitTtHor ∥ | |
| allowSplitQt ) && ( x0 + cbWidth <= pps_pic_width_in_luma_samples ) && | |
| ( y0 + cbHeight <= pps_pic_height_in_luma_samples ) ) | |
| split_cu_flag | ae(v) |
| if( pps_cu_qp_delta_enabled_flag && qgOnY && cbSubdiv <= CuQpDeltaSubdiv ) { | |
| IsCuQpDeltaCoded = 0 | |
| CuQpDeltaVal = 0 | |
| CuQgTopLeftX = x0 | |
| CuQgTopLeftY = y0 | |
| } | |
| if( sh_cu_chroma_qp_offset_enabled_flag && qgOnC && | |
| cbSubdiv <= CuChromaQpOffsetSubdiv ) { | |
| IsCuChromaQpOffsetCoded = 0 | |
| CuQpOffset_{Cb} = 0 | |
| CuQpOffset_{Cr} = 0 | |
| CuQpOffset_{CbCr} = 0 | |
| } | |
| if( split_cu_flag ) { | |
| if( ( allow SplitBtVer ∥ allowSplitBtHor ∥ allowSplitTtVer ∥ allowSplitTtHor ) && | |
| allowSplitQt ) | |
| split_qt_flag | ae(v) |
| if( !split_qt_flag ) { | |
| if( ( allowSplitBtHor ∥ allowSplitTtHor ) && | |
| ( allowSplitBtVer ∥ allowSplitTtVer ) ) | |
| mtt_split_cu_vertical_flag | ae(v) |
| if( ( allowSplitBtVer && allowSplitTtVer && mtt_split_cu_vertical_flag ) ∥ | |
| ( allowSplitBtHor && allowSplitTtHor && !mtt_split_cu_vertical_flag ) ) | |
| mtt_split_cu_binary_flag | ae(v) |
| } | |
| if( ModeTypeCondition = = 1 ) | |
| modeType = MODE_TYPE_INTRA | |
| else if( ModeTypeCondition = = 2 ) { | |
| non_inter_flag | ae(v) |
| modeType = non_inter_flag ? MODE_TYPE_INTRA : MODE_TYPE_INTER | |
| } else | |
| modeType = modeTypeCurr | |

### VVC Splitting Restrictions

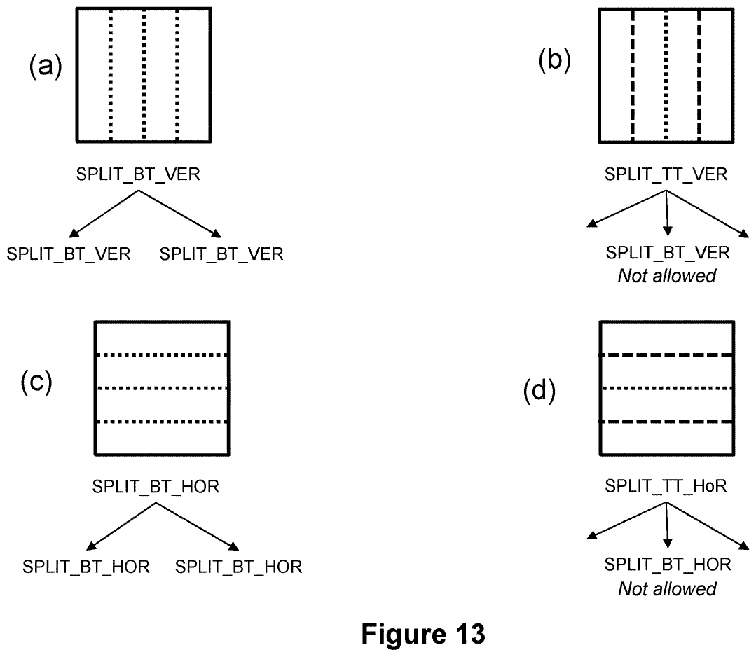

The VVC partitioning has several restrictions. These restrictions are mainly to avoid the same partitioning after several consecutive splits. FIG. 13 illustrates some of these constraints. The idea is to avoid the same partitioning with BT and TT. As depicted in FIG. 13(a) two consecutive vertical BT split are allowed but a vertical TT followed by a vertical BT split in the center block is not allowed as depicted in FIG. 13(b).

In the same way, as depicted in FIG. 13(c) two consecutive horizontal BT split are allowed but a horizontal TT followed by a horizontal BT split in the center block is not allowed as depicted in FIG. 13(d).

In VVC there are additional constraints for the minimum chroma block size and for the TT and BT maximum block size for inter block size. These constraints have been removed for the ECM software.

### Chroma Partitioning

In VVC, the Chroma partitioning may be inferred based on the Luma partitioning but this can be disabled. For example, according to a Dual tree mode, the partitioning tree of Chroma is independent to the tree of Luma. But some restrictions exist.

The tree can be also partially dependent to the Luma partitioning for the CCLM mode, otherwise, it is independent.

### Picture Boundary

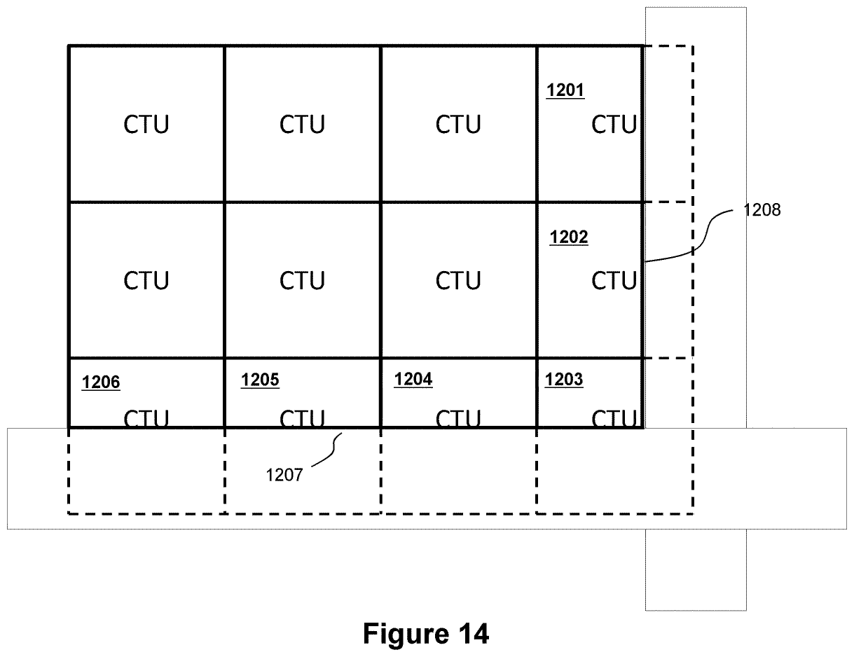

The frame resolution is not always equal to an integer multiple of CTU size. Consequently, there can be incomplete CTUs in the borders of the frame as depicted in FIG. 14 where CTUs 1201-1206 are incomplete due to the bottom and right boundaries 1207, 1208 of the frame. In VVC, in contrast to the previous standards, the signaling of the split is allowed at the picture boundary. The splitting process in the boundary is applied until that the coding tree node represents a CU located entirely within a picture. But some splits are inferred (not transmitted). Consequently, the different variables such as maxMttDepth, minQtDepth minQtSize, are increased or decreased and are possibly different to those used for the splits not in the boundary.

### QT BT TT Encoding Choice

In the VTM and ECM software several encoder side optimizations are used for the QT BT TT encoding choice.

One such optimization includes determining if the QT split is tested before the BT split. The condition is that at least one CU on the left or above the current coding tree node has a QT depth larger than the QT depth of the current coding tree node; and if the CU width represented by the current coding tree node is greater than minQtSize*2.

If this condition is true then the QT is tested before BT and the splits will be treated as the following order:
No Split
QT
BT Horizontal
BT Vertical
TT Horizontal
TT Vertical

Otherwise, the order will be:
No Split
BT Horizontal
BT Vertical
TT Horizontal
TT Vertical
QT

This order is important as according to some optimizations, several splits will not be tested depending on results of the first tested modes. So, when QT is tested last there is a lot of occasions where it will not be evaluated.

maxMttDepth

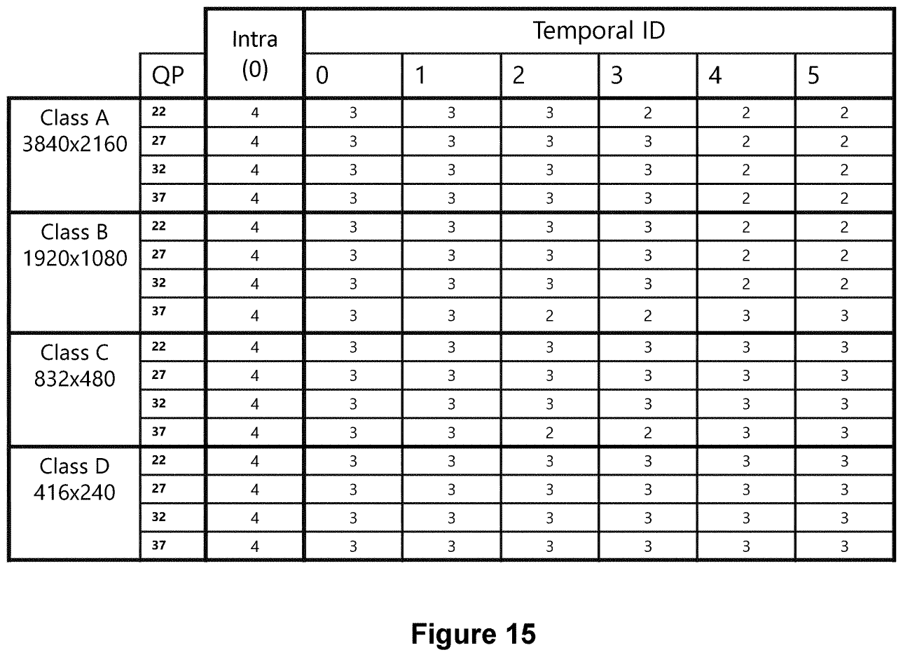

The maximum MTT depth has a significant impact on the encoder complexity. The common test conditions for the ECM have been updated to reduce the encoding by setting different maxMttDepths as depicted in FIG. 15. In this setting, the maxMttDepth is lower for some temporal ID for large resolutions or small QP settings.

Adaptive maxBtSize

In the VTM and ECM, there is a frame level encoding choice which sets the maxBtSize according to the average block sizes of the previous encoded frames with the same depth (=>same temporal ID within CTC RA case). The average block size is compared to thresholds as the following pseudo code:

```
  if( dBlkSize < AMAXBT_TH32 )
{
    newMaxBtSize = 32;
}
else if( dBlkSize < AMAXBT_TH64 )
{
    newMaxBtSize = 64;
}
      else if( dBlkSize < AMAXBT_TH128 )
{
    newMaxBtSize = 128;
}
else
{
    newMaxBtSize = 256;
}
```

Where AMAXBT_TH32 is equal to 15, AMAXBT_TH64 is equal to 30 and AMAXBT_TH128 is equal to 60. This method decreases the maximum BT size when the average block size is small and increases it when it is large.

### Temporal Prediction for CABAC:

In the ECM, a temporal CABAC prediction is used (JVET-Y0181). In this method, the previous slices are used for the CABAC initialization of the current frame. The probability state of each context model is first obtained after coding CTUs up to a specified location and stored. Then, the stored probability state is used as the initial probability state for the corresponding context model in the next B- or P-slice coded with the same quantization parameter (QP) or same corresponding temporal ID.

### Problem Solved by the Invention

In traditional video coding the temporal redundancies are exploited between samples thanks the Inter modes, between the motion information thanks to the different temporal candidates or predictors, and in the ECM the temporal redundancies between the CABAC probabilities are also used to improve the coding efficiency. Yet other data parameters, variables, syntax elements should have temporal correlation. But the traditional ways to exploit these redundancies seems not useful or not possible. For example, the solution of using a large number of predictors for samples as in the different Inter modes is not adapted for data with small amount of coding possibilities. The signaling of several candidates for motion information is useful as the motion is an information from the real word and it is very specific. But this is not useful for the prediction of parameters or variables or syntax elements. As well the prediction of the CABAC states is not adapted as it seems more a frame base QP prediction and not adapted to the different contents in a video sequence.

The present invention proposes a way to use temporal correlations between data and to determine efficiently the values used to predict these data.

### EMBODIMENTS

### Main Embodiment

Emb.Main Use of a temporal area to derive at least one value to predict or to infer or to determine a context increment for a syntax element, a syntax element or a variable.

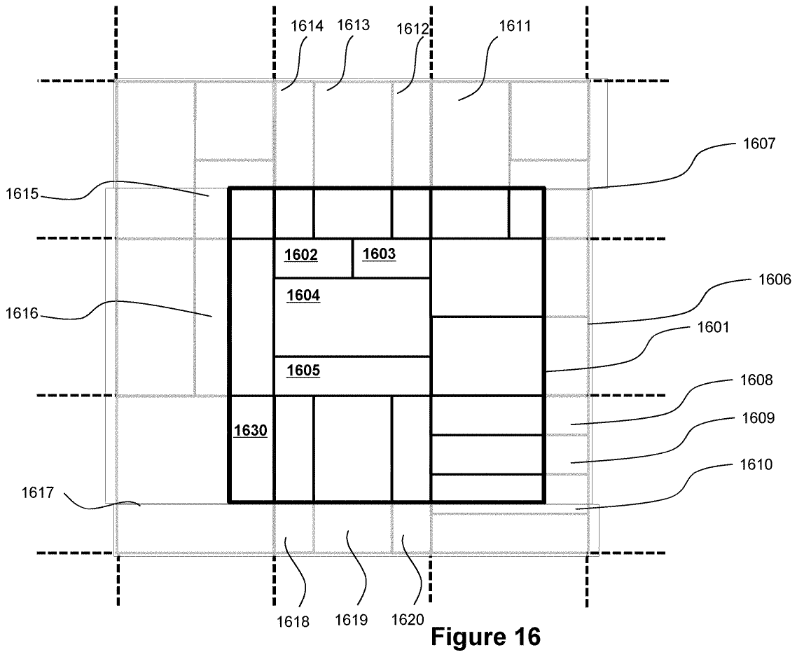

In an embodiment, a temporal area is used to derive at least one value to predict or to infer or to limit or to determine a variable or to code a syntax element or to compute a context increment for a syntax element. The value represents a similar variable or syntax element or another variable or another syntax element related. The temporal area comes from a temporal frame already encoded at encoder side or already decoded at decoder side. In one example, FIG. 16 illustrates this embodiment. In the figure the temporal area (1601) contains several blocks and some parts of blocks in the boundary of the temporal area. These blocks are considered to derive at least one value.

The advantage of this embodiment is a coding efficiency improvement thanks a better derivation of the predictors or the limits or the context increments. Compared to the methods used in the prior art, this method is more adapted to syntax elements or variables with reduced number of values.

Emb. Tempo_From1 Frame with the Same Temporal ID

In an embodiment, the temporal area comes from a frame with the same temporal ID.

For the example of the Random Access, configuration as represented in FIG. 9 if the current frame has a temporal ID equal to 4, another encoded/decoded frame with the same temporal ID 4 is used to determine the value associated to the temporal area.

The frames with the same temporal ID often have the same coding parameters, especially they have the same or similar QP and the same spatial distances to their reference frames. So, they are very interesting to predict the QT depth as this data is correlated to the QP and the spatial distance between frames.

Emb. Tempo_From1.1 Closest Frame with the Same Temporal ID In an embodiment, the temporal area comes from the closest frame with the same temporal ID.

For the example of the Random Access configuration, as represented in FIG. 9, the closest frame with the same temporal ID is (generally) more correlated than the others. So, the result is better.

Emb. Tempo_From2 Frame or a Reference Frame with the Same QP

In an embodiment, the temporal area comes from a frame or a reference frame with the same QP. Ideally, a reference frame with the same QP.

As mentioned above, the QP has an important influence on the block partitioning and many syntax elements and variable have similar value, So, with a frame with the same QP, the value determined from temporal are better.

Emb. Tempo_From3 Reference Frame is the Same as Used for the Temporal Motion Vector Prediction

In an embodiment, the temporal area comes from the reference frame which is used for the temporal motion vector prediction. This can be the first reference of the reference List 0 or the first reference frame of List 1 according to a flag transmitted in the picture header or in the slice header.

Surprisingly, this embodiment gives the best coding efficiency even if this reference frame has a lower QP. Yet, it is closer to the current frame compared to all frames with the same temporal ID.

Emb. Tempo_From4 Closest Reference Frame

In an embodiment, a temporal area comes from the closest reference frame.

As explained for the previous embodiment, the distance to the current frame seems more interesting for the compromise between encoder time reduction and coding efficiency even if the frames with the same QP have statistically more correlations between their QP depths.

Emb. Tempo_From5 More than One Reference Frame

In an embodiment, two temporal frames are considered and so two temporal areas are used to determine one value. More than two reference frames can also be considered.

The advantage is a better coding efficiency, but it increases the amount of memory accesses.

### Emb.Decim HLS Transmission of the Size N or M in a Header

In an embodiment, the value N of the grid for the decimation of the blocks of the temporal area and/or the value M of the grid for decimation of the decimation of the possible positions of the blocks are transmitted in the header. Additionally, or alternatively, others parameters as the non-regular grid can be also transmitted. Ideally as this as an impact on the memory buffer the value is transmitted in the sequence parameter set SPS. But if the value between N and M keep the same memory size needed these values can be transmitted alternatively in the PPS, picture header or Slice header.

### Size

### Emb.Larger the Size is Larger or Equal to the Size of the Current Block

In an embodiment, the size of temporal area is larger, if possible, than the current block. The aim of this embodiment is to determine a more useful value than the value that can be obtain with the collocated block.

One advantage is a better value for the variable to be predicted, inferred, determined or for the derivation of a context increment as the value determined is based on more values than the only collocated block. Of course, is adapted to some data in opposite, to the motion information. This advantage gives a coding efficiency improvement.

A second advantage, compared to a solution where the block is shifted according to a motion information (as temporal subblock), the motion information doesn't need to be determined. So, the parsing doesn't depend on the motion information which can't be obtained without a full decoding.

Another advantage, compared to one collocated from only one block, several values can be considered and others can be derived as the minimum, maximum average, etc., which gives more information to limit, to predict or to derive a context increment.

### Emb.Larger2 the Size of the Temporal Area is Larger or Equal to the Maximum Size of the Possible Block Size

In an embodiment, the temporal area is larger than or equal to the maximum size of the possible block size. For example, the temporal area is equal to the CTU size or larger.

This gives an interesting compromise between the coding efficiency and the complexity to determine the value.

### Emb.AdaptSize the Size is Adapted According to a Variable/Parameter

In an embodiment, the size of the temporal area is adapted according to at least one variable or at least one parameter.

The advantage of this embodiment is an increase of coding efficiency, especially when the temporal area is used to compensate the motion between two frames.

### Emb.AdaptSize1 Temporal Distance

In an embodiment, the size of the temporal area is determined based on the temporal distance between the current frame and the frame containing the temporal area. In this embodiment the temporal area increases when the temporal distance increase. For example, the absolute difference between the Picture Order Count (POC) of the current frame “currPOC” and the frame containing the temporal area “tempoPOC” is computed to take into account the temporal distance between frames. For example, the size of the temporal area (widthTempo, heightTempo) can be determined according to the following pseudo code:

$$widthTempo = widthTempoFix + 8 * abs ( currPOC - tempoPOC )$$

$$heightTempo = heightTempoFix + 8 * abs ( currPOC - tempoPOC )$$

where abs( ) is function given the absolute value. widthTempoFix and heightTempoFix are predetermined. For example, they are set equal to the CTU size. The number “8” in this formula is for an example but another value can be considered.

Additionally, the frame rate of the sequence can be considered to apply a weight to the absolute difference between POC.

The advantage is that the temporal area can compensate the motion between both frames and keep the temporal correlation between the variable or the syntax element to be predicted etc. . . . .

### Emb.AdaptSize2 QP Difference

In an embodiment, the size of the temporal area is determined based on the quantization parameter (QP) of the current frame and the QP of the frame containing the temporal area. Additionally, the size is determined based on the difference of the QP between these two frames. For example, the size of the temporal area increases when the QP of the current frame is lower than the QP of the temporal frame. And inversely it decreases when the QP of the current frame is higher than the QP of the temporal frame. Additionally, it can be proportional.

The advantage is a coding efficiency improvement. Indeed, the block sizes in a frame is related to the QP. Indeed, for a same frame coded, the block sizes are higher when the QP is higher. So, a larger temporal area when the QP is higher for the temporal frame than for the current frame increases the chance to find a correct value.

### Emb.AdaptSize3 Temporal ID, Depth

In an embodiment, the size of the temporal area is determined based on the temporal ID the current frame and the temporal ID of the temporal frame containing the temporal area. Additionally, this size can be proportional to the difference between the two temporal ID. For example, the size of the temporal area increases when the temporal ID of the temporal frame is less than the temporal ID for the current frame.

Alternatively, the hierarchical depth can be considered instead of the temporal ID.

The advantage is a coding efficiency improvement. Indeed, the frame with small temporal ID are often coded with larger temporal distance between frames. It is better to increase the temporal area for this case.

### Emb.AdaptSize4 A Value Transmitted in a Header

In an embodiment, the size of the temporal area is determined based a value transmitted in an header. The value can be transmitted alternatively or additionally in the SPS, PPS, Picture header, slice header. For example, the value is transmitted in the SPS and Predicted of inferred in the PPS. And an override flag indicates if this value is updated for the picture header or not compared to the value of the PPS or SPS.

The advantage is that the encoder implementation is not constraint and can be adapted to select between the coding efficiency and the complexity.

### Emb.AdaptSize5 The Size of the Current Block

In an embodiment, the size of the temporal area is determined based on the current block size. So, for larger blocks the temporal area is larger and smaller for smaller blocks. For example, if we consider a minimum temporal area size corresponding to the minimum possible block size, the size of the current block is added to this minimum size to obtain the final temporal are size corresponding to the current block.

This more adapted to the multiple block sizes.

### Blocks Inside the Temporal Area

### Emb.All_Blocks all Blocks of the Temporal Area

In an embodiment, the blocks considered to determine the value are all blocks of the temporal area. In the example of FIG. 16, the temporal area (1601) has not its borders aligned to the split partitioning. This corresponds to all blocks (1602 to 1620) which has at least one sample inside the temporal area (1601). So, 19 blocks are considered in this figure.

This is the simplest way to consider the blocks inside the temporal area.

### Emb.KeepProportion Blocks Inside the Temporal Area by Keeping the Proportion of Blocks

In an embodiment, when the blocks considered to determine the value are all blocks of the temporal area but the value extracted from the block are weighted to take into account only the part of the block which are inside the temporal area. For the example of FIG. 16, for the block 1617, a weight corresponding to the part 1630 is determined to compute for example an average of several values.

Compared to the previous embodiment, this one is more complex as some additional computations are needed, yet it increases the coding efficiency as it more locally adapted to the current block.

### Emb.FullyContain Blocks Fully Inside the Temporal Area

In an embodiment, alternatively to the previous one, the blocks considered to determine the value are blocks fully inside of the temporal area. In the example of FIG. 16, where the temporal area (1601) has not border aligned with the split partitioning this corresponds to all blocks 1601 to 1604. So, 4 blocks are considered.

The advantage of this embodiment is that it reduces the complexity to determine the value as less values need to be used for the computation. But not for the worst case when the temporal area matches the split partitioning.

### Position of Temporal Area Compared to the Current Block

### Emb.Center Center of the Block Position in the Current Frame

In an embodiment, the position of the center of the current block is the center of the temporal area in the temporal frame.

The center is in average the best representation of a block. So, the coding efficiency is better.

Alternatively, when the center of the block is outside the frame, the top left position can be considered.

Emb.shiftedBasedMV the Temporal Area can be Shifted According to the Motion Information

Even if, the temporal area can compensate the usage of the motion information for the parsing process, in an embodiment, the temporal area is shifted according to the motion vector. For example, a neighboring motion vector. This is particularly efficient if the motion information is large or the temporal distance is large between the current frame and the temporal frame of the collocated area.

### Decimation of the Temporal Area

Emb. Decimation One Position on N

In an embodiment, only the blocks present in a grid are considered to determine the value from the temporal area. In this embodiment only the block which are each multiple of N in the height and in the width are considered for the determination of the value.

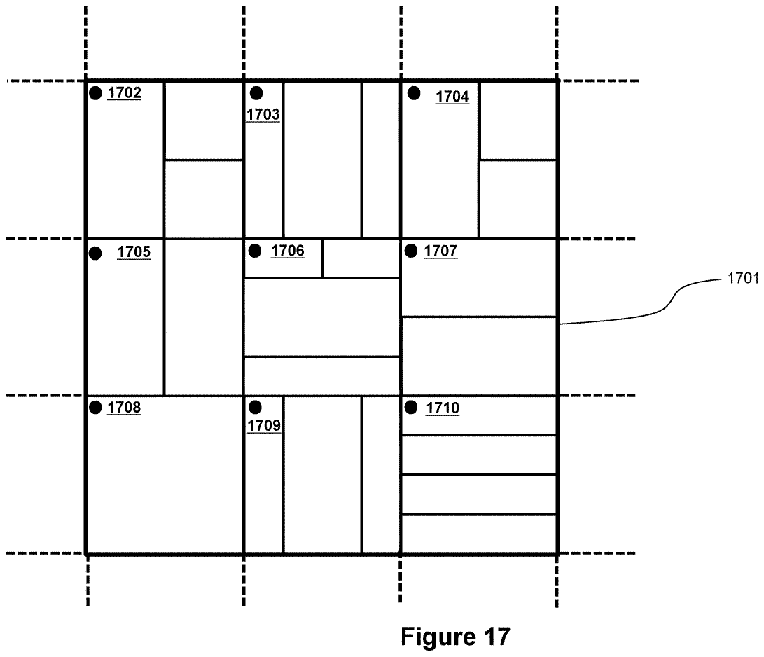

FIG. 17 shows an example of this embodiment. In this figure to determine the value from the temporal area 1701, only the blocks (1702 to 1710) in the grid N×N, represented by the dots, are used. Please note that in this figure, the temporal area is aligned with the split partitioning to simplify the description.

The main advantage is the reduction of the buffer needed to store the values which will be used to determine the value from the temporal area. Indeed, all values needed to determine this value need to be kept in memory for each frame that can be used as the frame of the temporal area. For hardware implementation, the worst case is considered to design the buffer. The worst case is the minimum block size in that case. As the minimum size if 8×4 or 4×8, it can be considered that the worst case the values are store for each 4×4 block. So, for a 1080p frame, (1920/4)*(1080/4)=129600 related values need to be stored for a temporal frame. If we consider for example that the value N is equal to 16 only (1920/16)*(1080/16)=8100 related information need to be store for a temporal frame. So, it reduces by 16 the information needed to be stored.

Another advantage is reduction of complexity when the partitioning contains small blocks. Indeed, it reduces the worst-case complexity as at the maximum the blocks on the grid need to be considered.

Moreover, it gives more importance of blocks with higher sizes which are a better representation of what happens in the temporal area in opposite to the small blocks which correspond to some areas less frequent. Consequently, the decimation is better. And, surprisingly, a coding efficiency improvement is obtained with this decimation. Especially when the value obtained from the temporal area is used to limit or to infer the variables of QT, BT, and TT. A decimation with N equals to 16 gives the best coding efficiency. If the temporal area is a CTU of 256×256 luma sample, only 256 blocks need to be considered for the worst case. In opposite without this decimation 2048 blocks need to be considered for the for worst case as the minimum block is 4×8 or 8×4.

### Emb.SumPropor Proportional to the Block Size (Especially for Data Representing Partitioning)

In an embodiment, only the blocks present in a grid are considered to determine the value from the temporal area and the size of the block is considered to compute an average for example. So, the value is obtained by considering a proportionality of blocks considered. This is also applied for the blocks in the boundary of the temporal area as described in a previous embodiment.

The advantage is a coding efficiency improvement compared to method which doesn't apply this proportionality.

### Emb.SumCenter the Positions N of the Grid are Centered

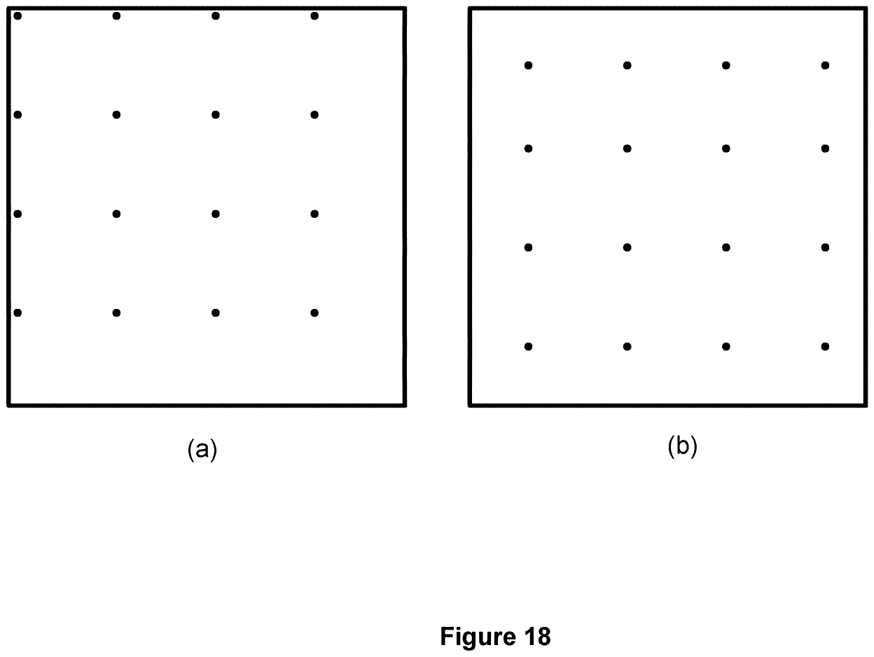

In an embodiment, the grid considered is centred compared to the temporal area. If we consider that the top left corner of the temporal area has the position (0,0), the top left position of the grid is (N/2,N/2). FIG. 18 (a) illustrates a grid non centred for a temporal area and FIG. 18 (b) illustrates a grid centred for a temporal area.

The advantage is a coding efficiency improvement as the values retained will be (in average) closer to the center of the current block

### Emb.SumNotReg a Nonregular Pattern

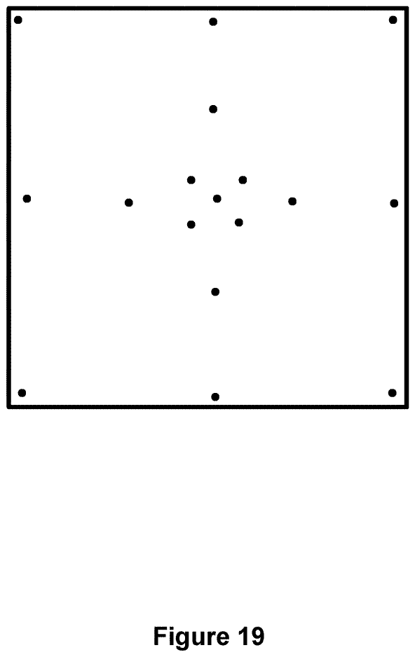

In an embodiment, the positions are in nonregular pattern. For example, more positions are considered in the center of the temporal area and the corner of the temporal area are also considered. FIG. 19 illustrates this nonregular pattern.

The advantage is sometimes a coding efficiency improvement.

### Decimation of Current Block Positions

Emb. CurrentPosDecim Possible Positions of the Blocks are Decimated

In an embodiment, the possible positions of the current blocks are decimated. In this embodiment, all possible positions for a block in the current frame are not possible. Only the positions on a grid every M samples in the height and in the width are considered.

For example, if we consider the center of the current block as the position of the temporal area, this position is the center of the temporal area only if both PosCenter.x and PosCenter.y are a multiple of M. Otherwise the position used is one of positions multiple of M around the initial PosCenter. For example, the position of the center of the temporal area PosTempo is obtained as the following:

$$PosTempo . x = M * ( PosCenter . x / M )$$

$$PosTempo . y = M * ( PosCenter . y / M )$$

In these formulas the divisions are integer divisions. Alternatively, it can be obtained thanks the following shifting operations:

$$PosTempo . x = ( PosCenter . x >> S ) << S$$

$$PosTempo . y = ( PosCenter . y >> S ) << S$$

Where >> is the left shift operator and << is the right shift operator and S=Log 2 (M)

The main advantage of this embodiment is the reduction of the memory buffer needed to store the values determined for the temporal area. This is particularly interesting for encoder implementation. Indeed, at encoder the value determined from temporal area can be determined several times for several block size having for example the same center. If all values need to be determined this is costly in term of memory. Similarly for the decimation of the block considered in the temporal area. With this decimation of possible center positions of the temporal area the buffer is significantly reduced (similar reduction with N=M).

In addition, it reduces the encoding time as less values need to be determined at encoder side.

And surprisingly, this decimation gives a coding efficiency improvement. This particularly true when the value obtained from the temporal area is used to limit or to infer the variables of QT, BT, and TT partitioning. A decimation with M equals to 16 gives the best coding efficiency.

### Emb.DecimCenter the Positions of the Grid are Centered

In an embodiment, the grid of possible block positions doesn't start from the top left position (0,0) of the frame but with a shift of (M/2, M/2) in order to a better decimation of the positions. This embodiment is similar to the grid centered to the center of the temporal area.

The advantage is a coding efficiency improvement.

### Emb.DecimBoth Decimation of Both, Temporal Area and Block Position

In an embodiment, both the decimation of the blocks of the temporal area and the possible positions are used together.

This gives also a coding efficiency improvement and complexity reduction.

Emb.Multiplecenter for Larger Block Considering Multiple Positions Inside this Buffer for Larger Block

The usage of a buffer reduces significantly the memory but can be constrained if the temporal area size depends on the current block size. In that case the value can't be store only once at encoder side.

In an embodiment, when the size of the current block is used to determine the size of the temporal area, and when the decimation of the possible positions for the current is used, all possible available positions which are contained in the block are considered and the values of all related temporal areas are considered to determine the value from the temporal area for the current block.

This embodiment as the same advantages as the usage of adapted the temporal area size according to the current block size. And additionally, it does not require more memory for the buffer than using a fixe size for the temporal area.

### Implementation

In many implementations, to access to an area in a previous frame the positions of this area are considered, and it is needed to go through the positions of the area to obtain the information of the blocks or CU present in this area. This is due to the structure of the buffer containing the information. Consequently, when it is needed to access to the temporal area to determine a value, the block structure is not known without going to each position. So, the basic solution consists in going through each position and computing the value associated to each position.

### Emb.Imple Current Implementation

In an embodiment, when the value from the temporal area is determined, the sizes of the blocks inside the temporal area are taking into account to avoid multiple accesses to a same block. So, each block has only one access. For example, a table of Boolean representing all possible positions inside the temporal area is initialized to value false. The possible positions in the temporal area are the positions of the grid N×N when the temporal area positions are decimated. The non-possible positions in this table are set equal to 1. The non-possible positions are the position outside the temporal frame. Each position has its corresponding in this table and set equal to false. When the position is checked in the temporal area the value is extracted and it is considered that the block is extracted. The related position inside the Boolean table is set equal to true and also all related positions corresponding to the current block associated to this position. The next position checked is then a block which has not yet been checked and the related Boolean in the table is equal to false.

Thanks to this implementation the determination of the value of the temporal area is faster.

### Emb.Pred Predict

In an embodiment, the temporal area is used to derive a predictor for a syntax element or a variable. For example, the syntax element, instead to be directly coded, a residual is extracted from the bitstream and the predictor is added to this residual. In an alternative example, a first bit is extracted from the bitstream to know if the current syntax element is set equal to the corresponding value obtained from the temporal area. If, for example, this flag is equal to 1, the syntax element is equal to the corresponding value from the temporal area. Otherwise, this flag is equal to 0, other bits are decoded to know the value of this syntax element.

The usage of the temporal area is very interesting in term of coding efficiency to obtained a corresponding value.

Emb. Infer Infer

In an embodiment, alternatively to the previous one, the value of the syntax element is inferred according to the corresponding value from the temporal area.

In an embodiment, a value of the variable for a block of the current frame is inferred thanks the corresponding value from the temporal area. For example, the maxMttDepth of the current block is determined based on a maxMttDepth determined from the temporal area “maxMttDepthTempo”. And according to some rules and the initial maxMttDepth for the current block compared to the “maxMttDepthTempo”, the value of maxMttDepth for the current block is increases or decreased or not changed.

The advantage of this example, is coding efficiency improvement with an encoding time reduction by limiting efficiently the maximum multi tree depth for the current block.

### Emb.Limit Limit

In an embodiment, a value determined from a temporal area is used to limit a syntax element or a variable. For example, a maximum value is determined and the syntax element value for the current block is limited to this maximum value. So its coding is adapted to this restricted number of values to reduce the number of bits needed to be transmitted. In the same way a minimum value can be considered or both a maximum and a minimum value.

Emb.Limit1.QTBT In another example, a variable is limited. For example, the minimum QT Depth form the temporal area is determined. And this value is used to determine the minimum value of the QT depth for the current block QT depth. Consequently, less bits for the QT split need to be transmitted and the encoding time decrease as fewer coding possibilities need to be tested.
Emb.Ctx Derive a Context Index Increment ctxInc

In an embodiment, a value determined from a temporal area is used to determine a context index increment of a syntax element. For example, the value obtained from the temporal area “condTempo” is added, if available (availableTempo=1), to the other context increments obtained from the spatial positions above (condA) and left (condL) as in the following formula:

$$ctxInc = ( condL \&\& availableL ) \vert \vert ( condA \&\& availableA ) \vert \vert ( condTempo \&\& availableTempo )$$

The advantage is a coding efficiency improvement as the syntax elements have generally spatial and temporal correlations.

### Value is

### Emb.Min Minimum

In an embodiment, the value to be determine from the temporal area is a minimum value from the blocks to be considered inside the temporal area

Emb.minQTDepth Particular Case of the minQTDepth

In a particular embodiment, the value to be determine from the temporal area is a minimum of QT depth values from the blocks to be considered inside the temporal area. For example, this minQTDepth is then compared to the current QT depth of the current block to determined if only the QT split is allowed or not.

This gives an encoding run time reduction and a coding efficiency improvement by limiting the number of possible splits to be tested and the related bits which are not signaled thanks to this solution.

### Emb.Max Maximum

In an embodiment, the value to be determine from the temporal area is a maximum value from the blocks to be considered inside the temporal area.

### Emb.MaxMttDepth Particular Case of the MaxMttDepth

In a particular embodiment, the value to be determine from the temporal area is a maximum of multi tree depth values from the blocks to be considered inside the temporal area. For example, this maxMttDepthTempo is then compared to the current maxMttDepth depth of the current block to determine, according to others conditions, if the maxMttDepth needs to be increased or decreased or stay the same.

This gives a coding efficiency improvement.

### Emb.Median Median

In an embodiment, the value to be determine from the temporal area is a median value from the blocks to be considered inside the temporal area.

### Emb.Average Average

In an embodiment, the value to be determine from the temporal area is an average value determined from the blocks to be considered inside the temporal area.

### Keep the Proportion of the Block Size in the Temporal Area

As mentioned previously for other embodiments, the proportion of the block size should be kept. In that case, the average should consider the number of samples that each block contains or alternatively a minimum block unit (the minimum block size (4×4)). In that case the for a block i the related value BLVal_i, the average AverageVal is obtained as the following:

$$AverageVal = 0$$

$$Nb\_samples = 0$$

For (i=0 to nb_blocks)

```
{
  AverageVal = AverageVal + BLVal_i * (height_i * width_i)
  Nb_samples = Nb_samples + (height_i * width_i)
}
AverageVal = AverageVal / Nb_samples
```

Where Nb_samples is the number of samples for all blocks in the temporal area, nb blocks is the number of blocks, height_i and width_i are the height and width of the block number i. In an alternative the height_i and the width_i can be respectively the height and the width in terms of temporal positions according to the decimation. For example, if the temporal decimation considered is set equal to 16 (one position in for 16 samples vertically and horizontally), the height and the width are divided by 16. Or right shifted by log 2(16)=4.

Additionally, a rounding process can be added to the formula as:

$$AverageVal = ( AverageVal + ( 0 \text{.5} ) ) / Nb\_samples$$

This rounding gives a coding efficiency improvement.
In an alternative
Average Val=0
Nb_samples=0
For (i=0 to nb_blocks)

```
{
  AverageVal = AverageVal + BLVal_i / (height_i * width_i)
  Nb_samples = Nb_samples + 1/ (height_i * width_i)
}
AverageVal = (AverageVal + (Nb_samples/2)) / Nb_samples
```

### Keep Only the Blocks Fully in the Temporal Area

When the blocks which cross the boundary of the temporal area, only the part inside the temporal area is considered, and the height_i and width_i for the related block correspond to the height and width inside the temporal area.

This can be implemented as the following algorithm:

$$AverageVal = 0$$

$$Nb\_samples = 0$$

For (i=0 to nb_blocks)

```
{
  AverageVal = AverageVal + (BLVal_i / (height_i * width_i) )/ blocksize
  Nb_samples = Nb_samples + (1* (height_i * width_i)) / blocksize
}
AverageVal = (AverageVal + (Nb_samples/2)) / Nb_samples
```

Where height_i and the width_i are respectively the height and the width in terms of temporal positions according to the decimation inside the temporal area.

So, if a part of the block is outside the temporal area, the number of positions outside of the temporal area, and according to the decimation, are respectively subtracted from the height_i and the width_i of the block i.

blocksize is equal to the number of samples of the current block i. So, it is the multiplication of the height and the width.

For hardware implementations, it is needed to use integer division. So, the formula needs to be adapted to the integer implementation. So, in one embodiment, the formula becomes in that case:

$$AverageVal = 0$$

$$Nb\_samples = 0$$

For (i=0 to nb blocks)

```
{
  AverageVal = AverageVal + (BLVal_i * (roundVal * (height_i * width_i) )/ blocksize)
  Nb_samples = Nb_samples + (roundVal/ (height_i * width_i)) / blocksize
}
AverageVal = (AverageVal + (Nb_samples/2)) / Nb_samples
```

Where the rounded value, roundVal is set equal as the following:

$$roundVal = ( tempoAreaWidth >> 2 ) * ( tempoAreaHeight >> 2 ) * ( tempoAreaWidth / TempoRes ) * ( tempoAreaHeight / TempoRes )$$

Where TempoRes corresponds to the decimation of the temporal area. So, 16, in the several examples mentioned previously.

And tempoAreaWidth and tempoAreaHeight are the height and the width of the temporal area. So, in the previously described examples, they can be equal to the CTU size.

According to the example mentioned previously, where the temporal area is set equal to the CTU size, and the decimation is equal to 16, the roundVal,is set equal:

$$roundVal = ( CTUSize >> 2 ) * ( CTUSize >> 2 ) * ( CTUSize / TempoRes ) * ( CTUSize / TempoRes )$$

With this rounding value the same results as a float division are obtained.

Additionally, all divisions can be replaced by right shift by considering the log 2 values.

### Emb.QTDepth Tempo Particular Case of the QTDepthTempo

In an embodiment, the value to be determined from the temporal area is an average of QT depth values from the blocks to be considered inside the temporal area. For example, this QTDepthTempo is then compared to the QT Depth of the current block to allow only the QT, No split and TT, or additionally or alternatively, it is compared to the QT Depth of the current block, and if it is equal and according to others conditions the maxMttDepth is increased.

This gives a coding efficiency improvement and an encoding time decrease.

Emb. Variance Variance

In an embodiment, the value to be determine from the temporal area is a variance of values from the blocks to be considered inside the temporal area. The variance is the average of the distances to the average. This requires determining the average first and then the variance. So, the blocks inside the temporal area are considered twice.

### Other

Emb. OTHER1 All these Embodiments can be Combined.

All the described embodiments can be combined unless explicitly stated otherwise. Indeed, many combinations are synergetic and may produce efficiency gains greater than a sum of their parts.

Emb. Contrib for the Contribution

In particular, a minimum QT depth “minQTDepthTempo”, a maximum multi tree depth “maxMttDepthTempo” and an average of depth values “QTDepthTempo” are determined from a temporal area. The minQTDepthTempo is then compared to the current QT depth of the current block to determine if only the QT split is allowed or not. The maxMttDepthTempo is compared to the current maxMttDepth depth of the current block. If it is inferior to the maxMttDepth, the maxMttDepth is decreased. If it is superior and if the QTDepthTempo is equal to the QT depth of the current block the maxMttDepth is increase. Moreover, the QTDepthTempo is compared to the QT Depth of the current block to allow only the QT, No split and TT. The temporal area is based on the reference frame which is used for the temporal motion vector prediction and it corresponds to the center of the current block. The temporal area is equal to the CTU size. Only the blocks present in a grid 16×16 are considered to determine the 3 values and the size of the block is considered to compute the average QTDepthTempo. So, the value is obtained by considering a proportionality between blocks. This is also applied for the blocks in the boundary of the temporal area. Eventually, the positions of the current blocks are decimated with a grid 16×16.

### Implementation of the Invention

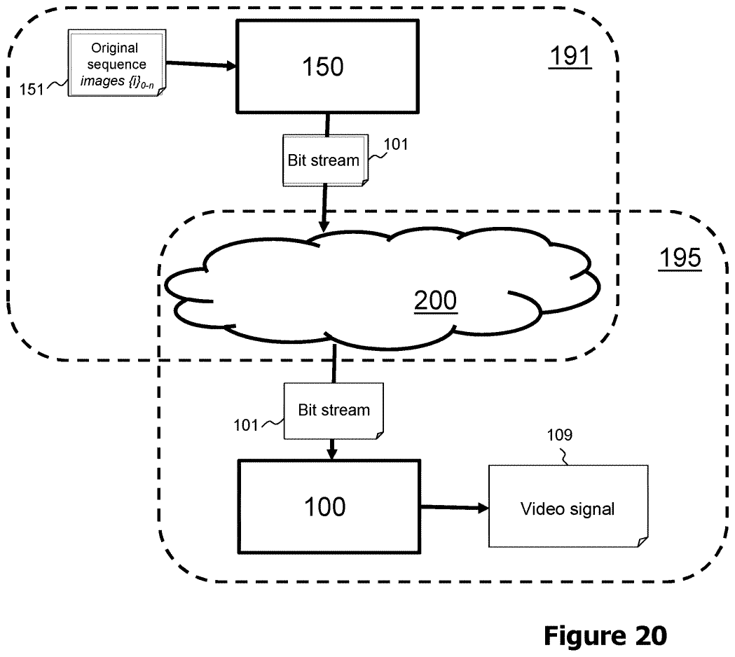

FIG. 20 shows a system 191 195 comprising at least one of an encoder 150 or a decoder 100 and a communication network 199 according to embodiments of the present invention. According to an embodiment, the system 195 is for processing and providing a content (for example, a video and audio content for displaying/outputting or streaming video/audio content) to a user, who has access to the decoder 100, for example through a user interface of a user terminal comprising the decoder 100 or a user terminal that is communicable with the decoder 100. Such a user terminal may be a computer, a mobile phone, a tablet or any other type of a device capable of providing/displaying the (provided/streamed) content to the user. The system 195 obtains/receives a bitstream 101 (in the form of a continuous stream or a signal—e.g. while earlier video/audio are being displayed/output) via the communication network 199. According to an embodiment, the system 191 is for processing a content and storing the processed content, for example a video and audio content processed for displaying/outputting/streaming at a later time. The system 191 obtains/receives a content comprising an original sequence of images 151, which is received and processed (including filtering with a deblocking filter according to the present invention) by the encoder 150, and the encoder 150 generates a bitstream 101 that is to be communicated to the decoder 100 via a communication network 191. The bitstream 101 is then communicated to the decoder 100 in a number of ways, for example it may be generated in advance by the encoder 150 and stored as data in a storage apparatus in the communication network 199 (e.g. on a server or a cloud storage) until a user requests the content (i.e. the bitstream data) from the storage apparatus, at which point the data is communicated/streamed to the decoder 100 from the storage apparatus. The system 191 may also comprise a content providing apparatus for providing/streaming, to the user (e.g. by communicating data for a user interface to be displayed on a user terminal), content information for the content stored in the storage apparatus (e.g. the title of the content and other meta/storage location data for identifying, selecting and requesting the content), and for receiving and processing a user request for a content so that the requested content can be delivered/streamed from the storage apparatus to the user terminal. Alternatively, the encoder 150 generates the bitstream 101 and communicates/streams it directly to the decoder 100 as and when the user requests the content. The decoder 100 then receives the bitstream 101 (or a signal) and performs filtering with a deblocking filter according to the invention to obtain/generate a video signal 109 and/or audio signal, which is then used by a user terminal to provide the requested content to the user.

Any step of the method/process according to the invention or functions described herein may be implemented in hardware, software, firmware, or any combination thereof. If implemented in software, the steps/functions may be stored on or transmitted over, as one or more instructions or code or program, or a computer-readable medium, and executed by one or more hardware-based processing unit such as a programmable computing machine, which may be a PC (“Personal Computer”), a DSP (“Digital Signal Processor”), a circuit, a circuitry, a processor and a memory, a general purpose microprocessor or a central processing unit, a microcontroller, an ASIC (“Application-Specific Integrated Circuit”), a field programmable logic arrays (FPGAs), or other equivalent integrated or discrete logic circuitry. Accordingly, the term “processor” as used herein may refer to any of the foregoing structure or any other structure suitable for implementation of the techniques describe herein.

Embodiments of the present invention can also be realized by wide variety of devices or apparatuses, including a wireless handset, an integrated circuit (IC) or a set of JCs (e.g. a chip set). Various components, modules, or units are described herein to illustrate functional aspects of devices/apparatuses configured to perform those embodiments, but do not necessarily require realization by different hardware units. Rather, various modules/units may be combined in a codec hardware unit or provided by a collection of interoperative hardware units, including one or more processors in conjunction with suitable software/firmware.

Embodiments of the present invention can be realized by a computer of a system or apparatus that reads out and executes computer executable instructions (e.g., one or more programs) recorded on a storage medium to perform the modules/units/functions of one or more of the above-described embodiments and/or that includes one or more processing unit or circuits for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more processing unit or circuits to perform the functions of one or more of the above-described embodiments. The computer may include a network of separate computers or separate processing units to read out and execute the computer executable instructions. The computer executable instructions may be provided to the computer, for example, from a computer-readable medium such as a communication medium via a network or a tangible storage medium. The communication medium may be a signal/bitstream/carrier wave. The tangible storage medium is a “non-transitory computer-readable storage medium” which may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. At least some of the steps/functions may also be implemented in hardware by a machine or a dedicated component, such as an FPGA (“Field-Programmable Gate Array”) or an ASIC (“Application-Specific Integrated Circuit”).

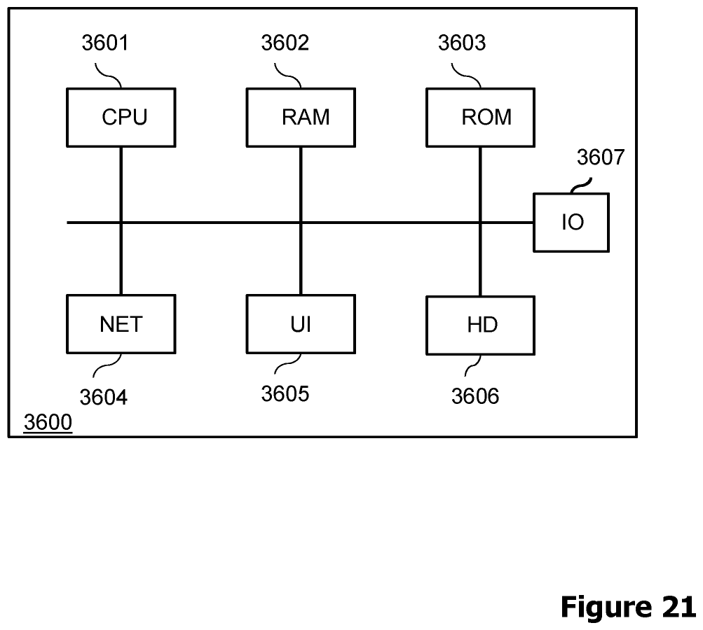

FIG. 21 is a schematic block diagram of a computing device 3600 for implementation of one or more embodiments of the invention. The computing device 3600 may be a device such as a micro-computer, a workstation or a light portable device. The computing device 3600 comprises a communication bus connected to: —a central processing unit (CPU) 3601, such as a microprocessor; —a random access memory (RAM) 3602 for storing the executable code of the method of embodiments of the invention as well as the registers adapted to record variables and parameters necessary for implementing the method for encoding or decoding at least part of an image according to embodiments of the invention, the memory capacity thereof can be expanded by an optional RAM connected to an expansion port for example; —a read only memory (ROM) 3603 for storing computer programs for implementing embodiments of the invention; —a network interface (NET) 3604 is typically connected to a communication network over which digital data to be processed are transmitted or received. The network interface (NET) 3604 can be a single network interface, or composed of a set of different network interfaces (for instance wired and wireless interfaces, or different kinds of wired or wireless interfaces). Data packets are written to the network interface for transmission or are read from the network interface for reception under the control of the software application running in the CPU 3601; —a user interface (UI) 3605 may be used for receiving inputs from a user or to display information to a user; —a hard disk (HD) 3606 may be provided as a mass storage device; —an Input/Output module (IO) 3607 may be used for receiving/sending data from/to external devices such as a video source or display. The executable code may be stored either in the ROM 3603, on the HD 3606 or on a removable digital medium such as, for example a disk. According to a variant, the executable code of the programs can be received by means of a communication network, via the NET 3604, in order to be stored in one of the storage means of the communication device 3600, such as the HD 3606, before being executed. The CPU 3601 is adapted to control and direct the execution of the instructions or portions of software code of the program or programs according to embodiments of the invention, which instructions are stored in one of the aforementioned storage means. After powering on, the CPU 3601 is capable of executing instructions from main RAM memory 3602 relating to a software application after those instructions have been loaded from the program ROM 3603 or the HD 3606, for example. Such a software application, when executed by the CPU 3601, causes the steps of the method according to the invention to be performed.

It is also understood that according to another embodiment of the present invention, a decoder according to an aforementioned embodiment is provided in a user terminal such as a computer, a mobile phone (a cellular phone), a table or any other type of a device (e.g. a display apparatus) capable of providing/displaying a content to a user. According to yet another embodiment, an encoder according to an aforementioned embodiment is provided in an image capturing apparatus which also comprises a camera, a video camera or a network camera (e.g. a closed-circuit television or video surveillance camera) which captures and provides the content for the encoder to encode. Two such examples are provided below with reference to FIGS. 37 and 38.

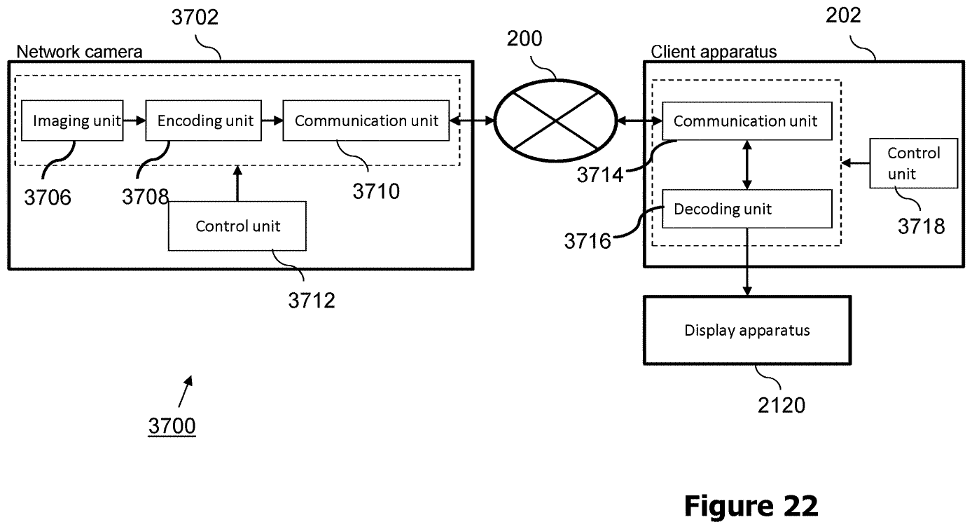

FIG. 22 is a diagram illustrating a network camera system 3700 including a network camera 3702 and a client apparatus 202.

The network camera 3702 includes an imaging unit 3706, an encoding unit 3708, a communication unit 3710, and a control unit 3712.

The network camera 3702 and the client apparatus 202 are mutually connected to be able to communicate with each other via the network 200.

The imaging unit 3706 includes a lens and an image sensor (e.g., a charge coupled device (CCD) or a complementary metal oxide semiconductor (CMOS)), and captures an image of an object and generates image data based on the image. This image can be a still image or a video image.

The encoding unit 3708 encodes the image data by using said encoding methods explained above, or a combination of encoding methods described above.

The communication unit 3710 of the network camera 3702 transmits the encoded image data encoded by the encoding unit 3708 to the client apparatus 202.

Further, the communication unit 3710 receives commands from client apparatus 202. The commands include commands to set parameters for the encoding of the encoding unit 3708.

The control unit 3712 controls other units in the network camera 3702 in accordance with the commands received by the communication unit 3712.

The client apparatus 202 includes a communication unit 3714, a decoding unit 3716, and a control unit 3718.

The communication unit 3714 of the client apparatus 202 transmits the commands to the network camera 3702.

Further, the communication unit 3714 of the client apparatus 202 receives the encoded image data from the network camera 3712.

The decoding unit 3716 decodes the encoded image data by using said decoding methods explained above, or a combination of the decoding methods explained above.

The control unit 3718 of the client apparatus 202 controls other units in the client apparatus 202 in accordance with the user operation or commands received by the communication unit 3714.

The control unit 3718 of the client apparatus 202 controls a display apparatus 2120 so as to display an image decoded by the decoding unit 3716.

The control unit 3718 of the client apparatus 202 also controls a display apparatus 2120 so as to display GUI (Graphical User Interface) to designate values of the parameters for the network camera 3702 includes the parameters for the encoding of the encoding unit 3708.

The control unit 3718 of the client apparatus 202 also controls other units in the client apparatus 202 in accordance with user operation input to the GUI displayed by the display apparatus 2120.

The control unit 3718 of the client apparatus 202 controls the communication unit 3714 of the client apparatus 202 so as to transmit the commands to the network camera 3702 which designate values of the parameters for the network camera 3702, in accordance with the user operation input to the GUI displayed by the display apparatus 2120.

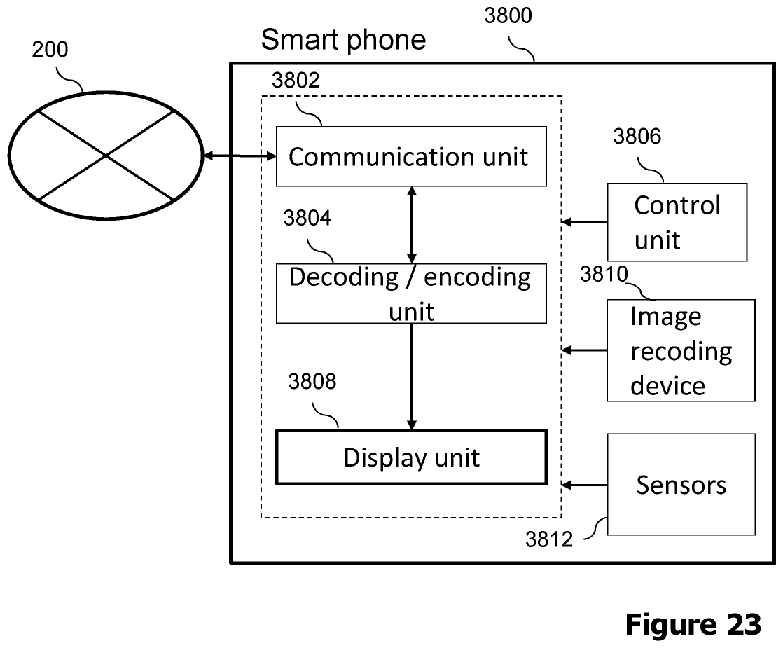

FIG. 23 is a diagram illustrating a smart phone 3800.

The smart phone 3800 includes a communication unit 3802, a decoding unit 3804, a control unit 3806 and a display unit 3808.

the communication unit 3802 receives the encoded image data via network 200.

The decoding unit 3804 decodes the encoded image data received by the communication unit 3802.

The decoding/encoding unit 3804 decodes/encodes the encoded image data by using said decoding methods explained above.

The control unit 3806 controls other units in the smart phone 3800 in accordance with a user operation or commands received by the communication unit 3806.

For example, the control unit 3806 controls a display unit 3808 so as to display an image decoded by the decoding unit 3804. The smart phone 3800 may also comprise sensors 3812 and an image recording device 3810. In such a way, the smart phone 3800 may record images, encode the images (using a method described above).

The smart phone 3800 may subsequently decode the encoded images (using a method described above) and display them via the display unit 3808—or transmit the encoded images to another device via the communication unit 3802 and network 200.

### ALTERNATIVES AND MODIFICATIONS

While the present invention has been described with reference to embodiments, it is to be understood that the invention is not limited to the disclosed embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

It is also understood that any result of comparison, determination, assessment, selection, execution, performing, or consideration described above, for example a selection made during an encoding or filtering process, may be indicated in or determinable/inferable from data in a bitstream, for example a flag or data indicative of the result, so that the indicated or determined/inferred result can be used in the processing instead of actually performing the comparison, determination, assessment, selection, execution, performing, or consideration, for example during a decoding process.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

Reference numerals appearing in the claims are by way of illustration only and shall have no limiting effect on the scope of the claims.

1. A method of decoding video data from a bitstream, the bitstream comprising video data corresponding to a plurality of frames arranged in a decoding order, the method comprising:
deriving a value from a first area in a first frame of the plurality of frames; and
determining, from the value, a context increment for a syntax element, or a syntax element, or a variable related to a second area in a second frame,
wherein the first frame precedes the second frame in the decoding order.

2. The method according to claim 1, wherein each frame of the plurality of frames has an associated temporal ID, and wherein the first frame and the second frame have the same temporal ID.

3. The method according to claim 2, wherein the first frame corresponds to the closest frame to the second frame, in the decoding order, that has the same temporal ID.

4. The method according to claim 1, wherein each frame of the plurality of frames has an associated quantization parameter, QP, and wherein the first frame and the second frame have the same QP.

5. (canceled)

6. (canceled)

7. The method according to claim 1, wherein the second area corresponds to a coding tree unit, CTU.

8. The method according to claim 1, wherein a size of the first area is set based on a temporal distance between the first frame and the second frame.

9. The method according to claim 8, wherein the temporal difference is calculated based on a difference between a picture order count, POC, of the first frame and a POC of the second frame.

10. The method according to claim 1, wherein each frame of the plurality of frames has an associated quantization parameter, QP, and wherein a size of the first area is set based on a difference between a QP of the first frame and a QP of the second frame.

11. (canceled)

12. The method according to claim 1, wherein a size of the first area is set based on a value transmitted in one of: a sequence parameter set; a picture parameter set; a picture header; and a slice header, contained within the bitstream.

13. The method according to claim 1, wherein a size of the first area is set based on a size of the second area.

14. The method according to claim 1, wherein the step of deriving a value from a first area in a first frame of the plurality of frames comprises deriving a value from a block that has at least one sample within the first area.

15. The method according to claim 1, wherein the step of deriving a value from a first area in a first frame of the plurality of frames comprises deriving a value from all blocks having at least one sample within the first area.

16. The method according to claim 14, wherein the step of deriving a value from a first area in a first frame of the plurality of frames comprises weighting the value derived from the or each block based on the number of samples of each block has within the first area.

17. (canceled)

18. The method according to claim 1, wherein the step of deriving a value from a first area in a first frame of the plurality of frames comprises deriving a value only from blocks that are completely contained within the first area.

19. The method according to claim 1, wherein the step of deriving a value from a first area in a first frame of the plurality of frames comprises deriving a value only from blocks that are located on an N×N grid within the first area, where N is an integer.

20. (canceled)

21. The method according to claim 19, wherein a center of the grid is located at the same position within the first frame as a center of the first area with the first frame.

22. A The method according to claim 1, wherein the step of deriving a value from a first area in a first frame of the plurality of frames comprises deriving a value only from blocks that are located on points of a pattern within the first area.

23. The method according to claim 22, wherein the points of the pattern are spaced in a non-uniform manner.

24. (canceled)

25. A The method according to claim 1, wherein the step of determining, from the value, a context increment for a syntax element, or a syntax element, or a variable, related to a second area in a second frame comprises determining a context increment for a syntax element, or a syntax element, or a variable, related to blocks located on an M×M grid within the second area, where M is an integer.

26. The method according to claim 25, wherein the M×M grid is shifted by M/2 in a horizontal direction and M/2 in a vertical direction relative to a top-left position of the second area.

27. The method according to claim 1, wherein a center of the first area is located at the same position within the first frame as a center of the second area within the second frame.

28. The method according to claim 1, wherein the center of the first area is located at the position within the first frame corresponding to a center of the second area within the second frame shifted by an amount corresponding to a motion vector derived from an area neighbouring the second area.

29. The method according to claim 1, further comprising, when the center of the first area lies outside the first frame, deriving a value from a top left position of the first area.

30. The method according to claim 1, wherein the step of deriving a value from a first area in a first frame of the plurality of frames comprises accessing each block within the first area only once.

31. The method according to claim 1, wherein the step of deriving a value from a first area in a first frame of the plurality of frames comprises:
deriving a value from a first area in a first frame of the plurality of frames and a third area in a third frame of the plurality of frames.

32. The method according to claim 1, wherein the step of determining, from the value, a context increment for a syntax element, or a syntax element, or a variable, related to a second area in a second frame, comprises determining a predictor to be added to a residual derived from the bitstream.

33. The method according to claim 1, wherein the value derived from the first area comprises maxMttDepth, and the step of determining, from the value, a context increment for a syntax element, or a syntax element, or a variable, related to a second area in a second frame comprises determining maxMttDepth for a block of the second area.

34. (canceled)

35. The method according to claim 1, wherein the value derived from the first area is a minimum of quadtree depth values, minQTDepth, from the blocks of the first area, and the step of determining, from the value, a context increment for a syntax element, or a syntax element, or a variable, related to a second area in a second frame comprises comparing the derived minQTDepth to a quadtree depth of a block in the second area to determine if only the quadtree split is allowed.

36. The method according to claim 1, wherein the value derived from the first area is a maximum maximum of multi tree depth values, maxMttDepth, from the blocks of the first area, and the step of determining, from the value, a context increment for a syntax element, or a syntax element, or a variable, related to a second area in a second frame comprises comparing the derived maxMttDepth to a maxMttDepth of a block in the second area, and varying maxMttDepth based on the comparison.

37. The method according to claim 1, wherein the value derived from the first area is an average of quadtree depth values from the blocks of the first area, and the step of determining, from the value, a context increment for a syntax element, or a syntax element, or a variable, related to a second area in a second frame comprises comparing the derived quadtree depth values to a quadtree depth of a block in the second area.

38. The method according to claim 37, further comprising the step of determining allowable splits based on the comparison.

39. The method according to claim 37, further comprising the step of varying maxMttDepth based on the comparison.

40. A device for decoding video data from a bitstream, the bitstream comprising video data corresponding
one or more processors configured to:
derive a value from a first area in a first frame of the plurality of frames; and
determine, from the value, a context increment for a syntax element, or a syntax element, or a variable related to a second area in a second frame,
wherein the first frame precedes the second frame in the decoding order.

41. A method of encoding video data into a bitstream, the bitstream comprising video data corresponding to a plurality of frames arranged in a decoding order, the method comprising:
deriving a value for a first area in a first frame of the plurality of frames; and
determining, from the value, a context increment for a syntax element, or a syntax element, or a variable related to a second area in a second frame, wherein the first frame precedes the second frame in the decoding order.

42-79. (canceled)

80. A device for encoding video data into a bitstream, the bitstream comprising video data corresponding to a plurality of frames arranged in a decoding order, the device comprising:
one or more processors configured to:
derive a value for a first area in a first frame of the plurality of frames; and
determine, from the value, a context increment for a syntax element, or a syntax element, or a variable related to a second area in a second frame,
wherein the first frame precedes the second frame in the decoding order.

81. (canceled)

82. A non-transitory, computer-readable storage medium carrying a computer program comprising instructions which, when the program is executed by one or more processors of a device for decoding video data from a bitstream, cause the one or more processing units to:
derive a value from a first area in a first frame of the plurality of frames; and
determine, from the value, a context increment for a syntax element, or a syntax element, or a variable related to a second area in a second frame,
wherein the first frame precedes the second frame in the decoding order.

83. A non-transitory, computer readable storage medium carrying a computer program comprising instructions which, when the program is executed by one or more processors of a device for encoding video data into a bitstream, cause the one or more processors to:
derive a value for a first area in a first frame of the plurality of frames; and
determine, from the value, a context increment for a syntax element, or a syntax element, or a variable related to a second area in a second frame,
wherein the first frame precedes the second frame in the decoding order.
